(19) United States
(12) Patent Application Publication
(10) Pub. No.: US 2016/0357357 A1
(43) Pub. Date: Dec. 8, 2016

(54) Device, Method, and Graphical User Interface for Manipulating Related Application Windows

(71) Applicant: Apple Inc., Cupertino, CA (US)

(72) Inventors: Stephen Olivier Lemay, Palo Alto, CA (US); Patrick Lee Coffman, San Francisco, CA (US); Tiffany Jon, Cupertino, CA (US)

(21) Appl. No.: 15/171,178

(22) Filed: Jun. 2, 2016

Related U.S. Application Data
(60) Provisional application No. 62/172,157, filed on Jun. 7, 2015.

(51) Int. Cl. G06F 3/0481; G06F 3/0488; G06F 3/0484; G06F 3/0482; G06F 3/041; G06F 3/01

(52) U.S. Cl. CPC G06F 3/0481; G06F 3/0414; G06F 3/0416; G06F 3/016; G06F 3/04845; G06F 3/0482; G06F 3/0488

(57) ABSTRACT

In accordance with some embodiments, a method is performed at an electronic device with a display, one or more input devices, one or more processors, and a non-transitory memory. The method includes displaying a navigation window of an application and an interface object associated with the navigation window; and while displaying the navigation window and the interface object, detecting selection of the interface object. In response to detecting selection of the interface object the method includes adjusting display of the navigation window in order to provide display space adjacent to a first edge of the navigation window; and displaying a content-creation window as at least partially overlapping the provided display space that was occupied by the navigation window immediately before the display of the navigation window was adjusted in order to provide the display space.

### TECHNICAL FIELD

This relates generally to electronic devices with touch-sensitive surfaces, including but not limited to electronic devices with touch-sensitive surfaces that detect inputs for manipulating user interfaces.

### BACKGROUND

The use of touch-sensitive surfaces as input devices for computers and other electronic computing devices has increased significantly in recent years. Exemplary touch-sensitive surfaces include touch pads and touch screen displays. Such surfaces are widely used to manipulate user interface objects on a display.

Exemplary manipulations include adjusting the position and/or size of one or more user interface objects or activating buttons or opening files/applications represented by user interface objects, as well as associating metadata with one or more user interface objects or otherwise manipulating user interfaces. Exemplary user interface objects include digital images, video, text, icons, control elements such as buttons and other graphics. A user will, in some circumstances, need to perform such manipulations on user interface objects in a file management program (e.g., Finder from Apple Inc. of Cupertino, Calif.), an image management application (e.g., Aperture or iPhoto from Apple Inc. of Cupertino, Calif.), a digital content (e.g., videos and music) management application (e.g., iTunes from Apple Inc. of Cupertino, Calif.), a drawing application, a presentation application (e.g., Keynote from Apple Inc. of Cupertino, Calif.), a word processing application (e.g., Pages from Apple Inc. of Cupertino, Calif.), a website creation application (e.g., iWeb from Apple Inc. of Cupertino, Calif.), a disk authoring application (e.g., iDVD from Apple Inc. of Cupertino, Calif.), or a spreadsheet application (e.g., Numbers from Apple Inc. of Cupertino, Calif.).

But methods for performing these manipulations are cumbersome and inefficient. For example, using a sequence of mouse based inputs to select one or more user interface objects and perform one or more actions on the selected user interface objects is tedious and creates a significant cognitive burden on a user. In addition, these methods take longer than necessary, thereby wasting energy. This latter consideration is particularly important in battery-operated devices.

### SUMMARY

Accordingly, there is a need for electronic devices with faster, more efficient methods and interfaces for manipulating user interfaces. Such methods and interfaces optionally complement or replace conventional methods for manipulating user interfaces. Such methods and interfaces reduce the cognitive burden on a user and produce a more efficient human-machine interface. For battery-operated devices, such methods and interfaces conserve power and increase the time between battery charges.

The above deficiencies and other problems associated with user interfaces for electronic devices with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device has a touchpad. In some embodiments, the device has a touch-sensitive display (also known as a “touch screen” or “touch screen display”). In some embodiments, the device has a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive surface. In some embodiments, the functions optionally include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions are, optionally, included in a non-transitory computer readable storage medium or other computer program product configured for execution by one or more processors.

In accordance with some embodiments, a method is performed at an electronic device with a display, one or more input devices, one or more processors, and a non-transitory memory. The method includes displaying a navigation window of an application and an interface object associated with the navigation window; and while displaying the navigation window and the interface object, detecting selection of the interface object. In response to detecting selection of the interface object the method includes adjusting display of the navigation window in order to provide display space adjacent to a first edge of the navigation window; and displaying a content-creation window as at least partially overlapping the provided display space that was occupied by the navigation window immediately before the display of the navigation window was adjusted in order to provide the display space.

In accordance with some embodiments, an electronic device includes a display unit configured to display a graphical user interface, one or more input units configured to receive user inputs, and a processing unit coupled to the display unit and the one or more user inputs. The processing unit is configured to enable display of a navigation window of an application and an interface object associated with the navigation window. While displaying the navigation window and the interface object, the processing unit is configured to detect selection of the interface object. In response to detecting selection of the interface object, the processing unit is configured to: adjust display of the navigation window in order to provide display space adjacent to a first edge of the navigation window; and enable display of a content-creation window as at least partially overlapping the provided display space that was occupied by the navigation window immediately before the display of the navigation window was adjusted in order to provide the display space.

In accordance with some embodiments, an electronic device includes a display, one or more input devices, one or more processors, a non-transitory memory, and one or more programs; the one or more programs are stored in the non-transitory memory and configured to be executed by the one or more processors and the one or more programs include instructions for performing or causing performance of any of the methods described herein. In accordance with some embodiments, a non-transitory computer readable storage medium has stored therein instructions which when executed by an electronic device with a display and one or more input devices, cause the device to perform or cause performance of any of the methods described herein. In accordance with some embodiments, an electronic device includes: a display, one or more input devices, and means for performing or causing performance of any of the methods described herein. In accordance with some embodiments, a graphical user interface on an electronic device with a display, one or more input devices, a non-transitory memory, and one or more processors to execute one or more programs stored in the non-transitory memory includes one or more of the elements displayed in any of the methods described herein, which are updated in response to inputs, as described in any of the methods described herein. In accordance with some embodiments, an information processing apparatus, for use in an electronic device with a display and one or more input devices, includes means for performing or causing performance of any of the methods described herein.

Thus, electronic devices with displays and one or more input devices are provided with faster, more efficient methods and interfaces for manipulating user interface objects, thereby increasing the effectiveness, efficiency, and user satisfaction with such devices. Such methods and interfaces may complement or replace conventional methods for manipulating user interface objects.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIGS. 5A-5N illustrate exemplary user interfaces for manipulating related windows of an application and/or related tiled windows of the application in accordance with some embodiments.

FIGS. 6A-6E are flow diagrams illustrating a method of manipulating related windows of an application and/or related tiled windows of the application in accordance with some embodiments.

FIG. 7 is a functional block diagram of an electronic device in accordance with some embodiments.

### DESCRIPTION OF EMBODIMENTS

Many electronic devices have graphical user interfaces that use applications windows. Because a user may use one or more instances of a particular application at once, application windows are useful tools for organizing items stored in electronic devices and using features provided by various applications. A user may need to manipulate, organize, configure and/or resize application windows. Some methods for manipulating, organizing, configuring and/or resizing application windows require a sequence of user inputs that navigate in a menu system. For example, with these methods, a user may need to select a user interface object in display a menu and/or perform one or more actions on the selected user interface object associated with one or more application windows. The various methods disclosed herein streamline manipulating, organizing, configuring and/or resizing application windows.

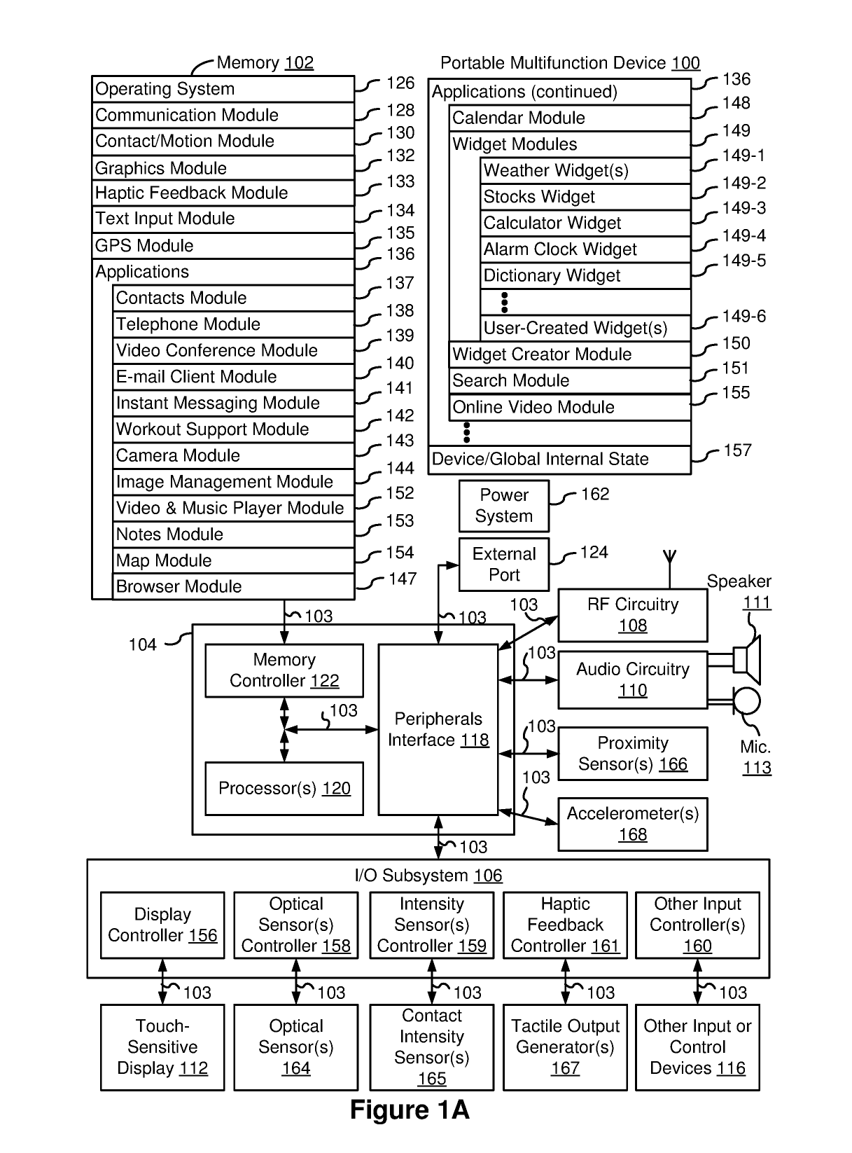

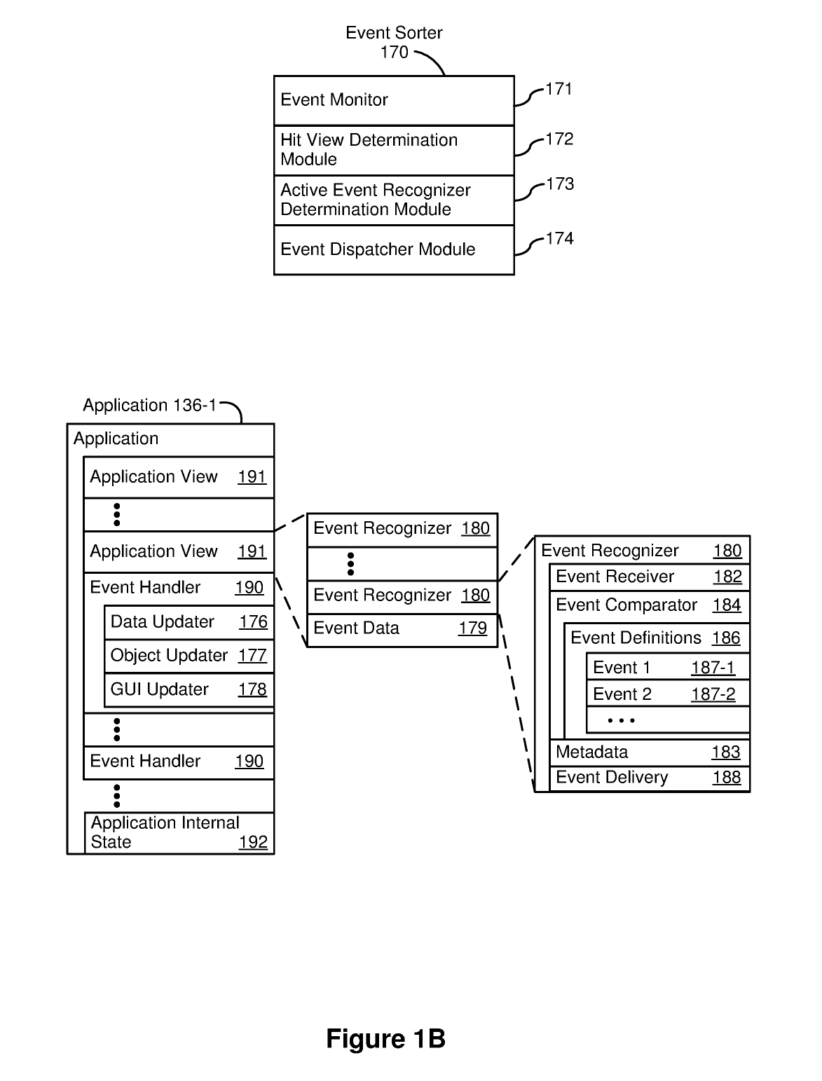

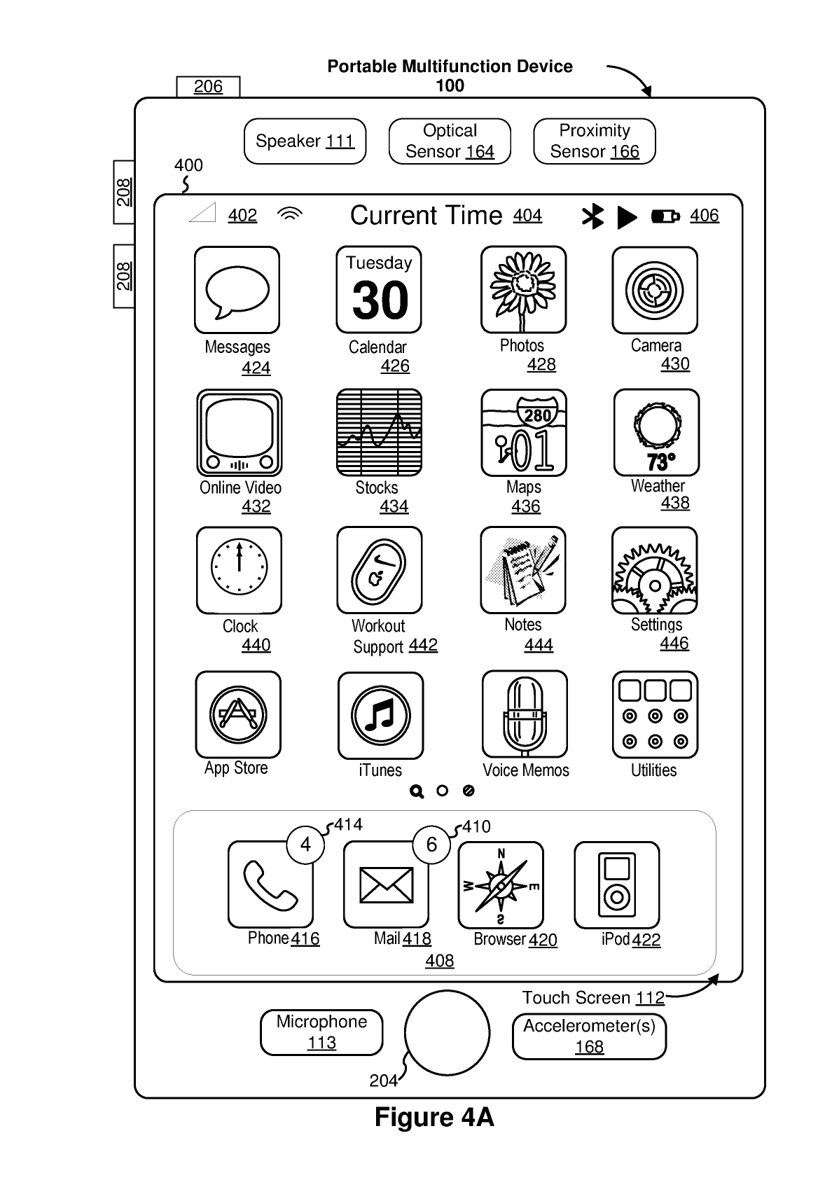

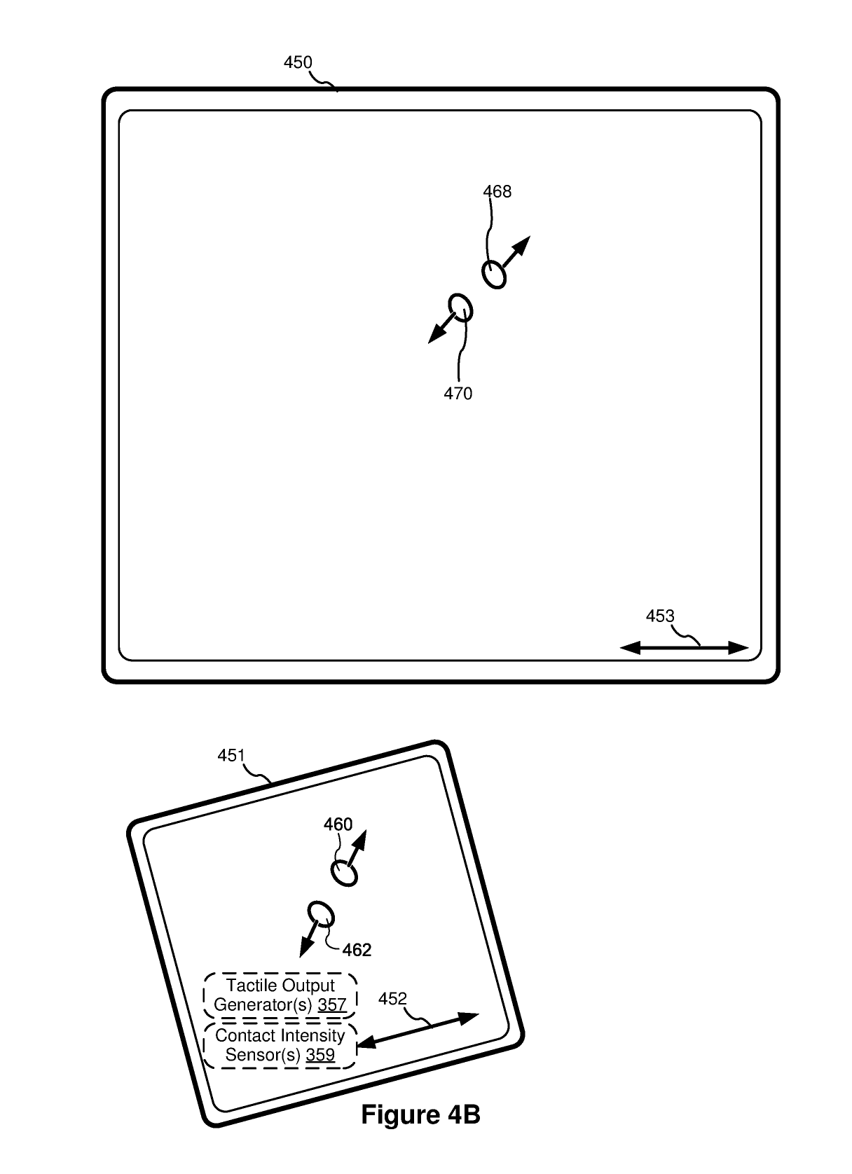

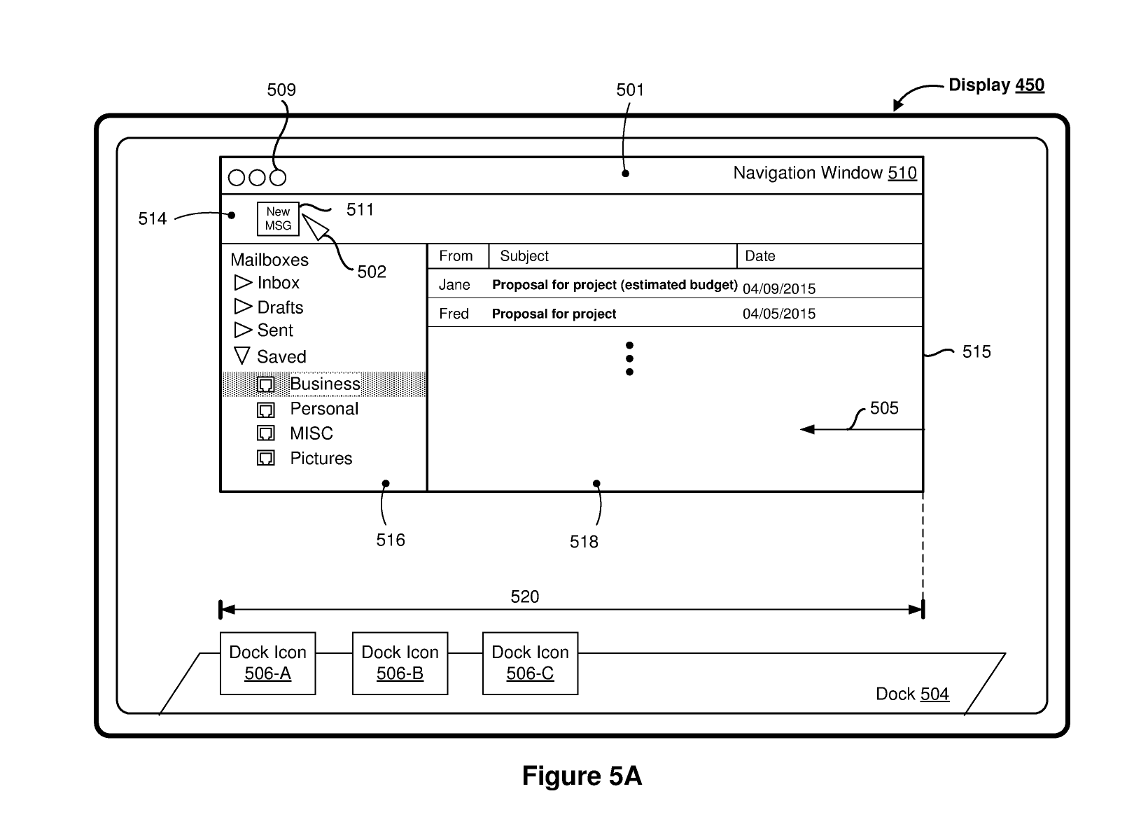

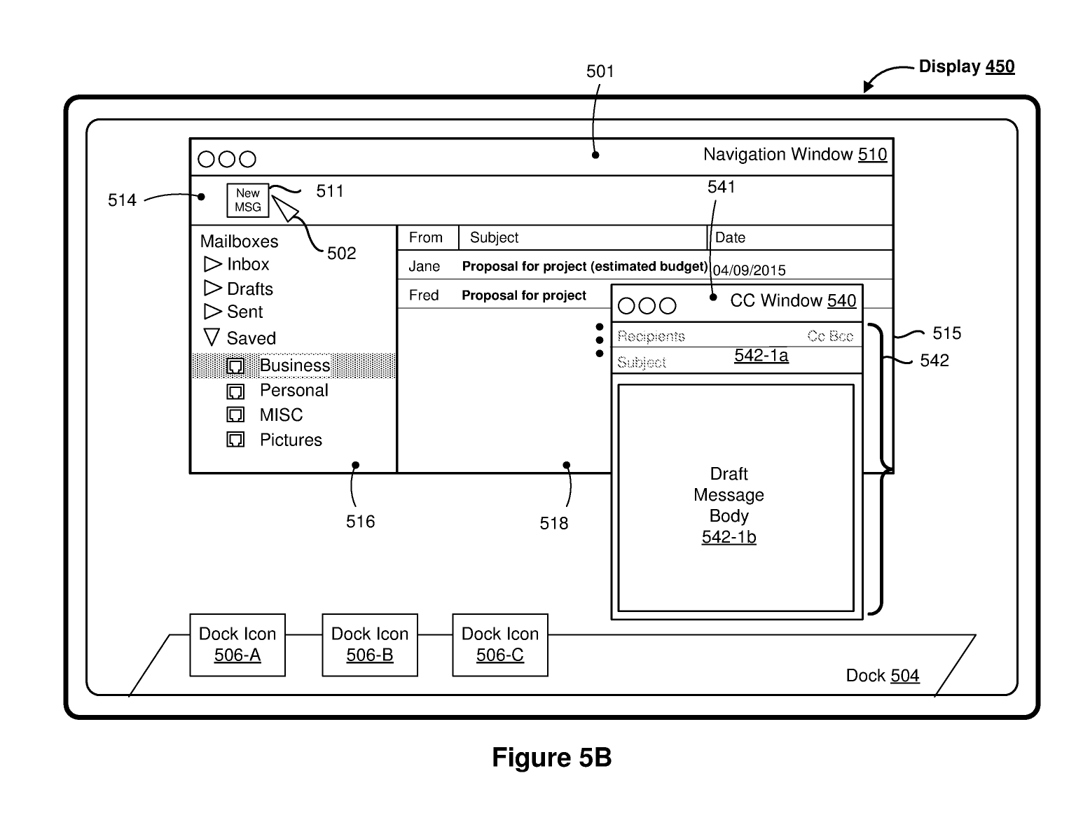

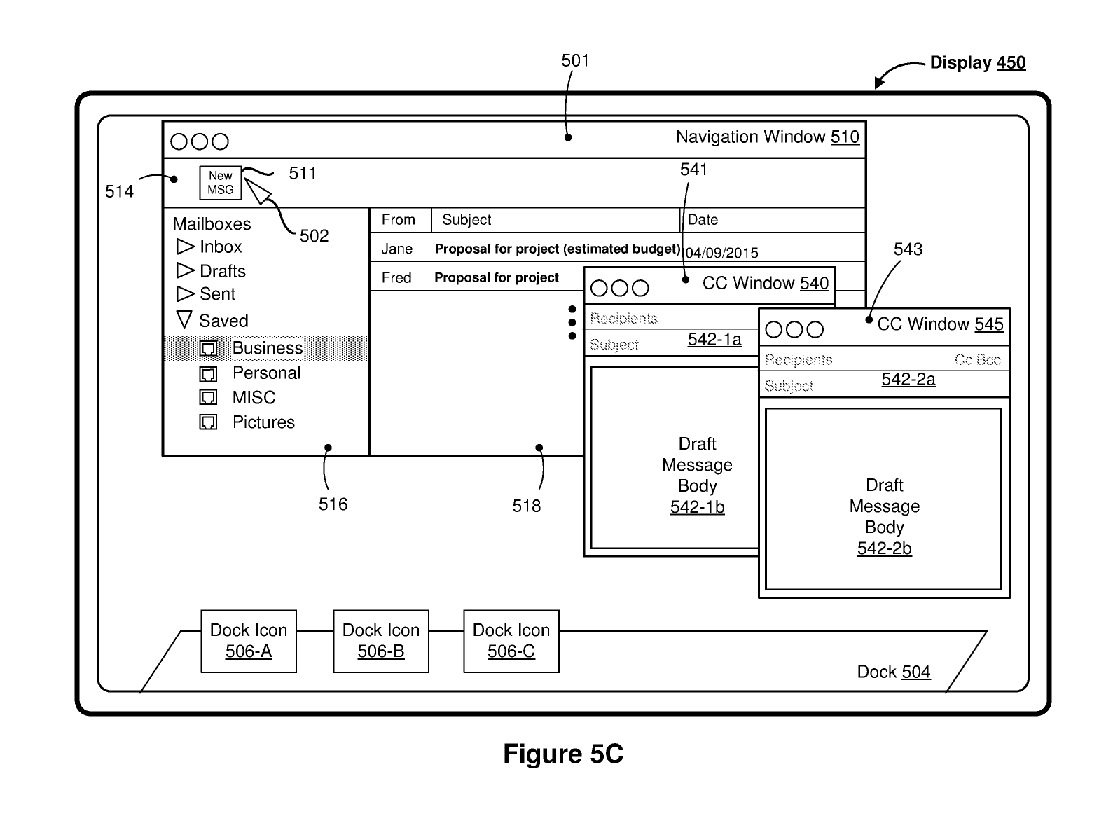

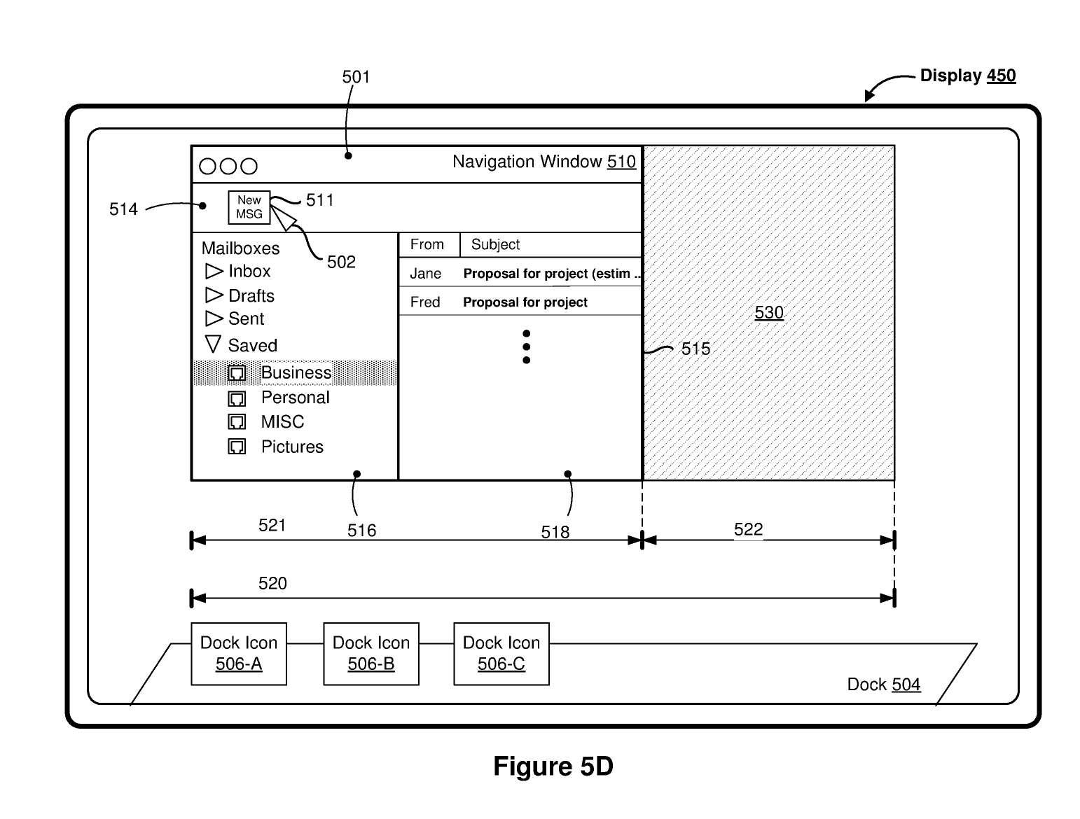

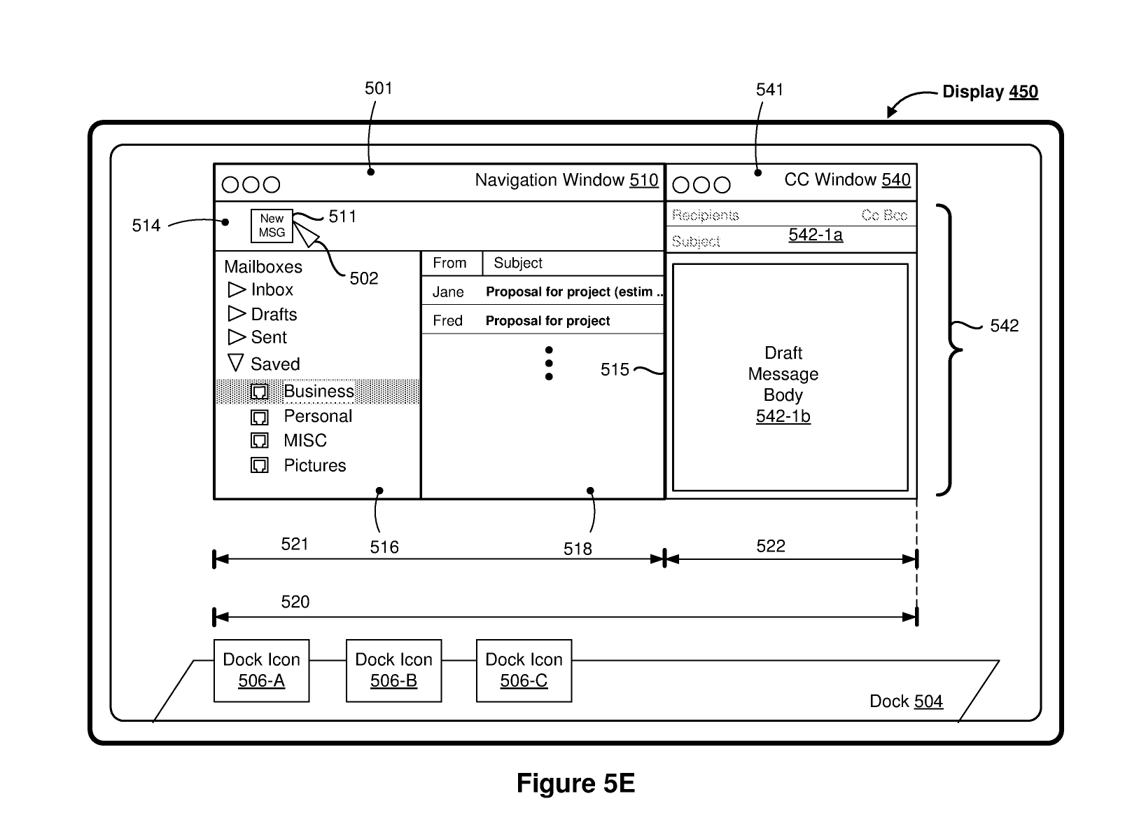

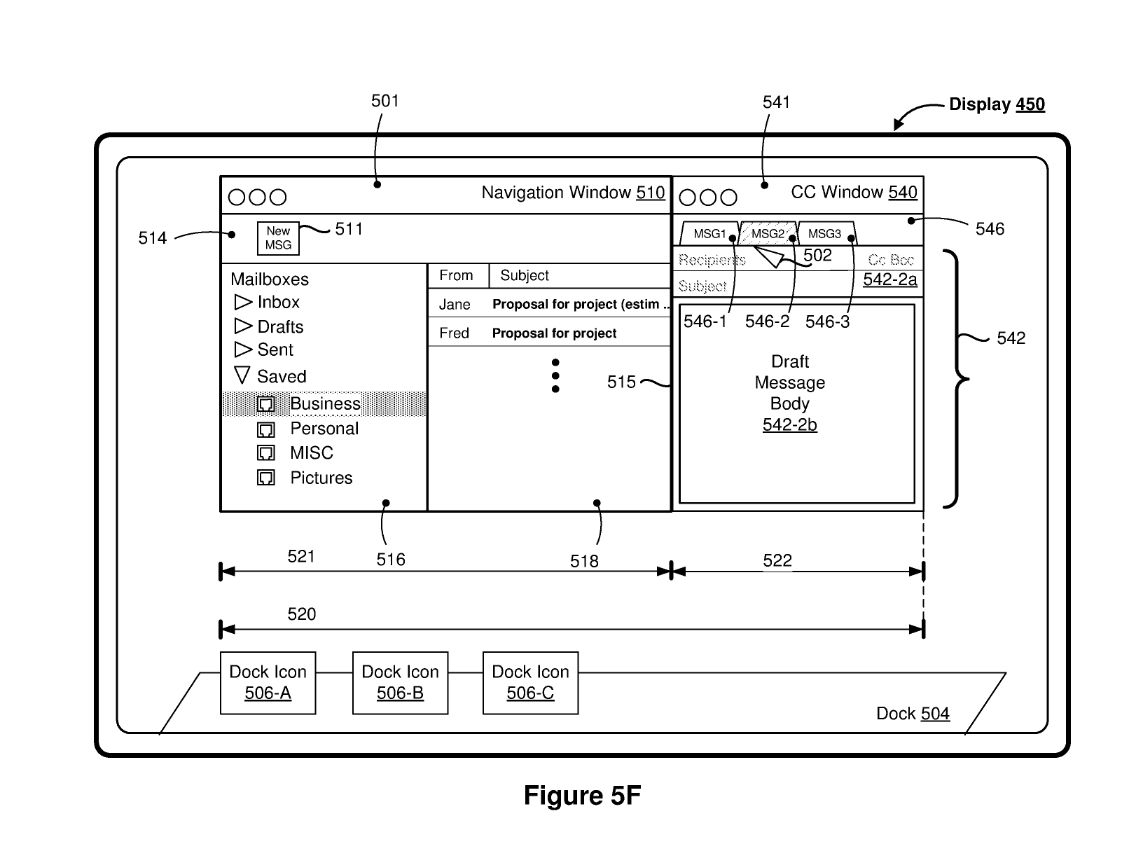

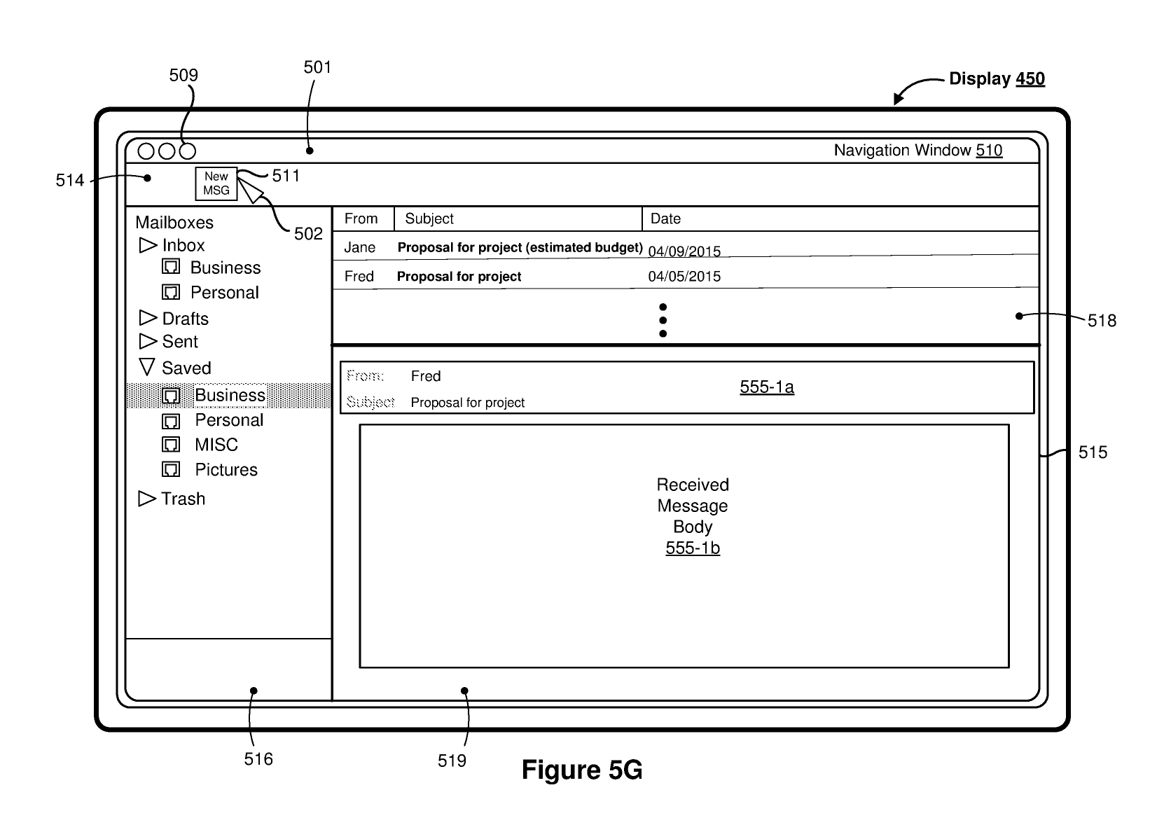

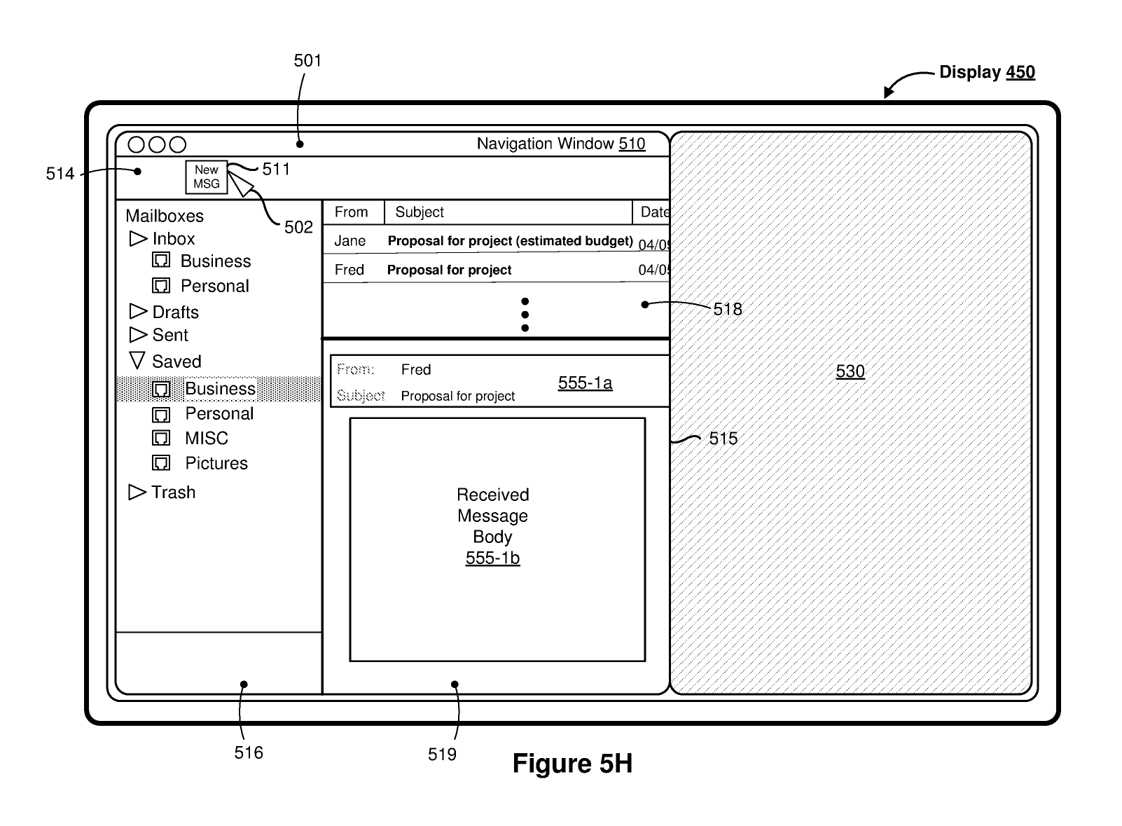

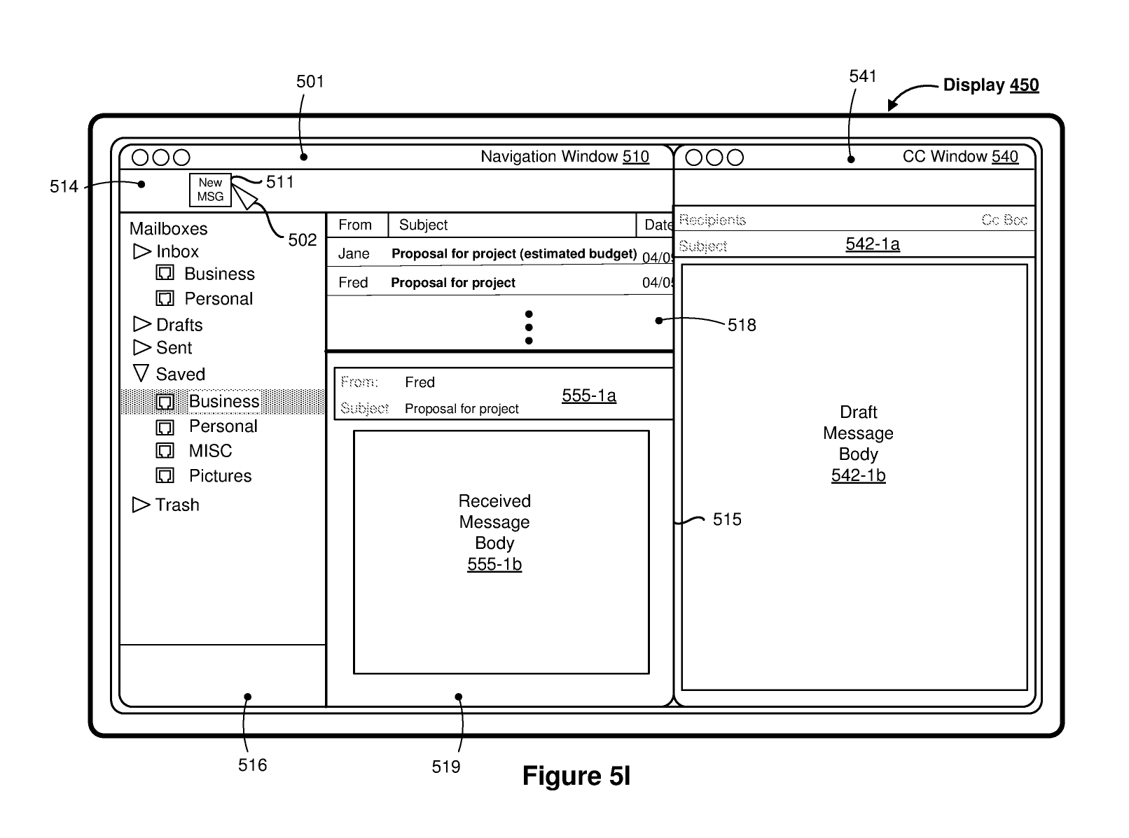

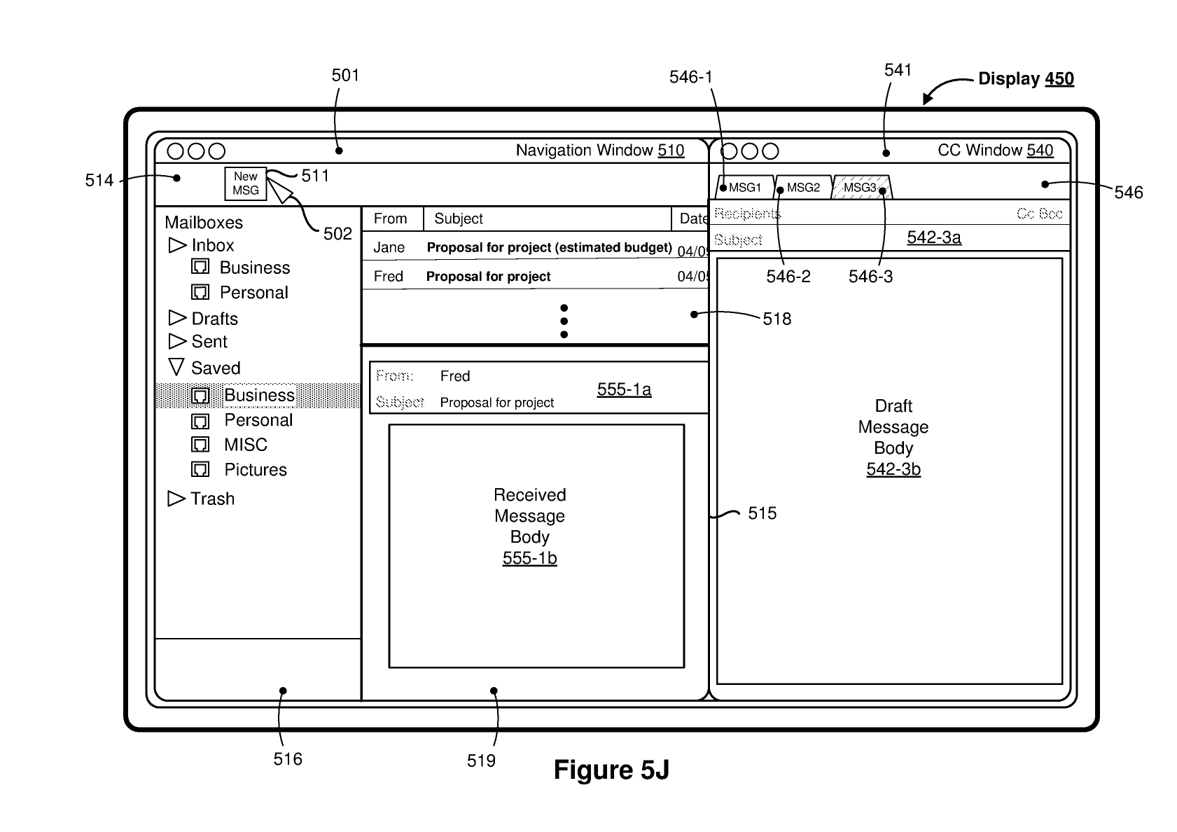

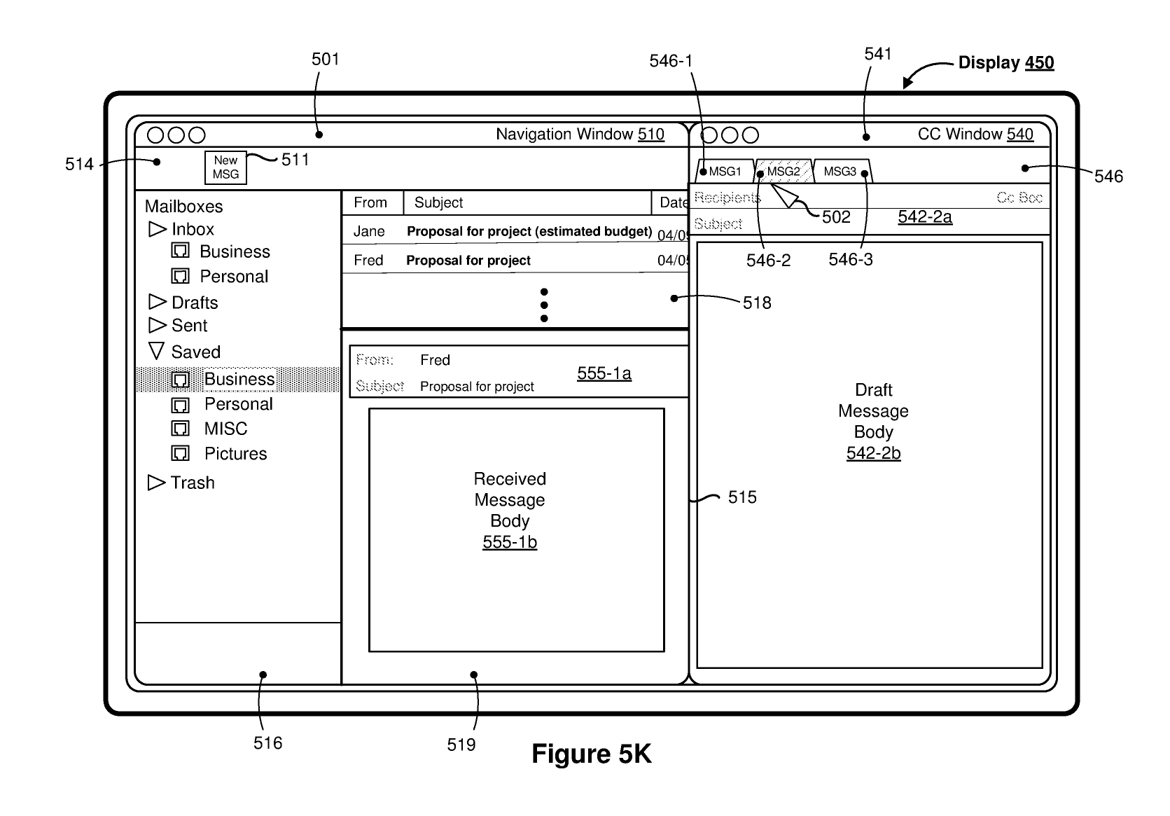

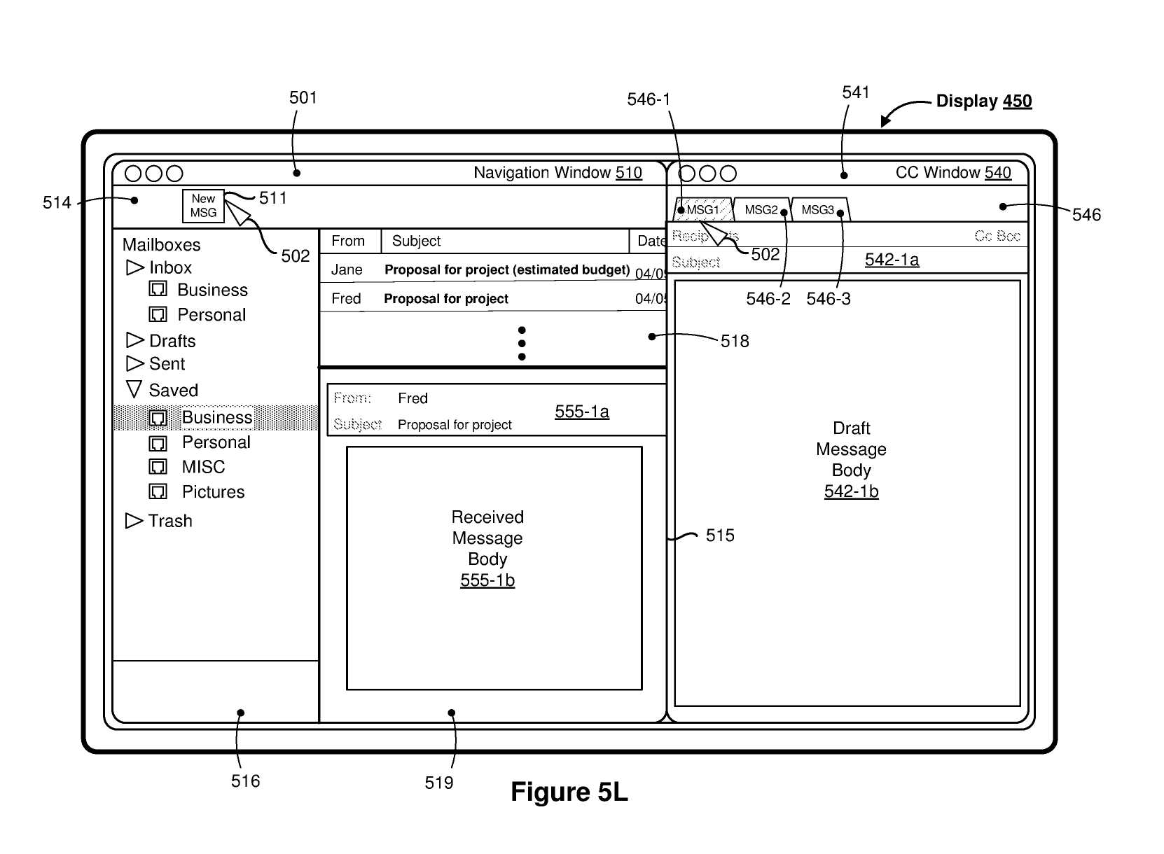

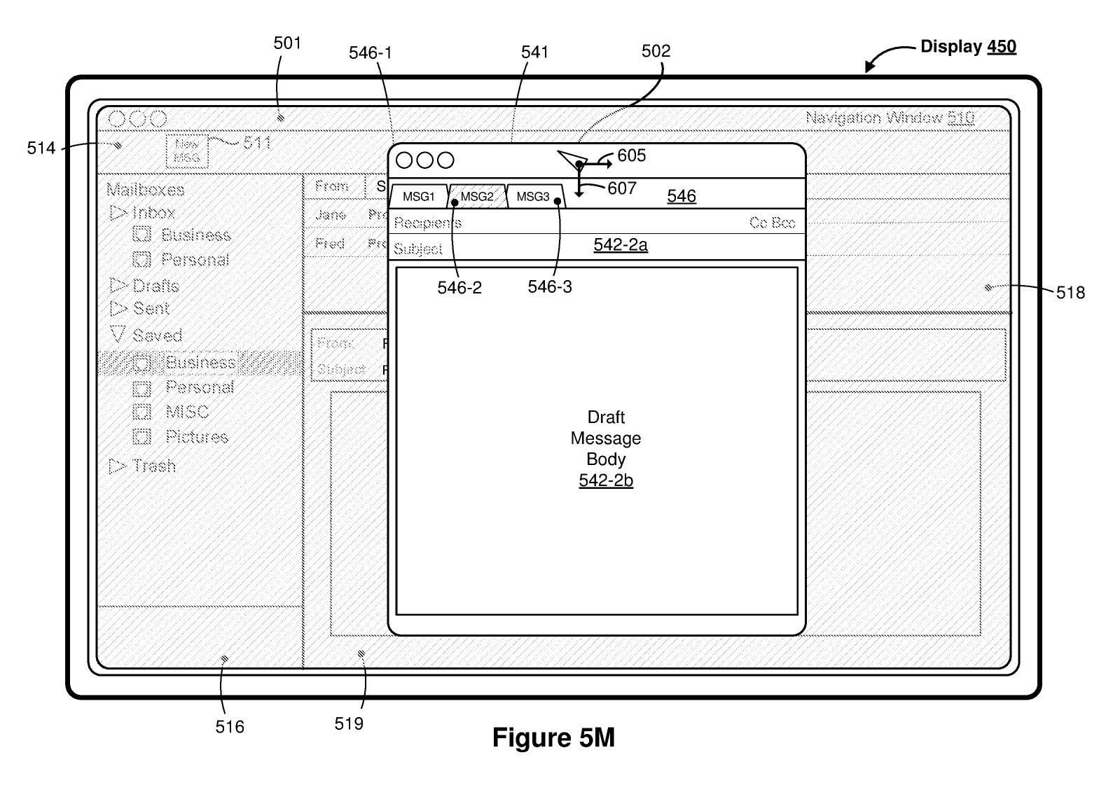

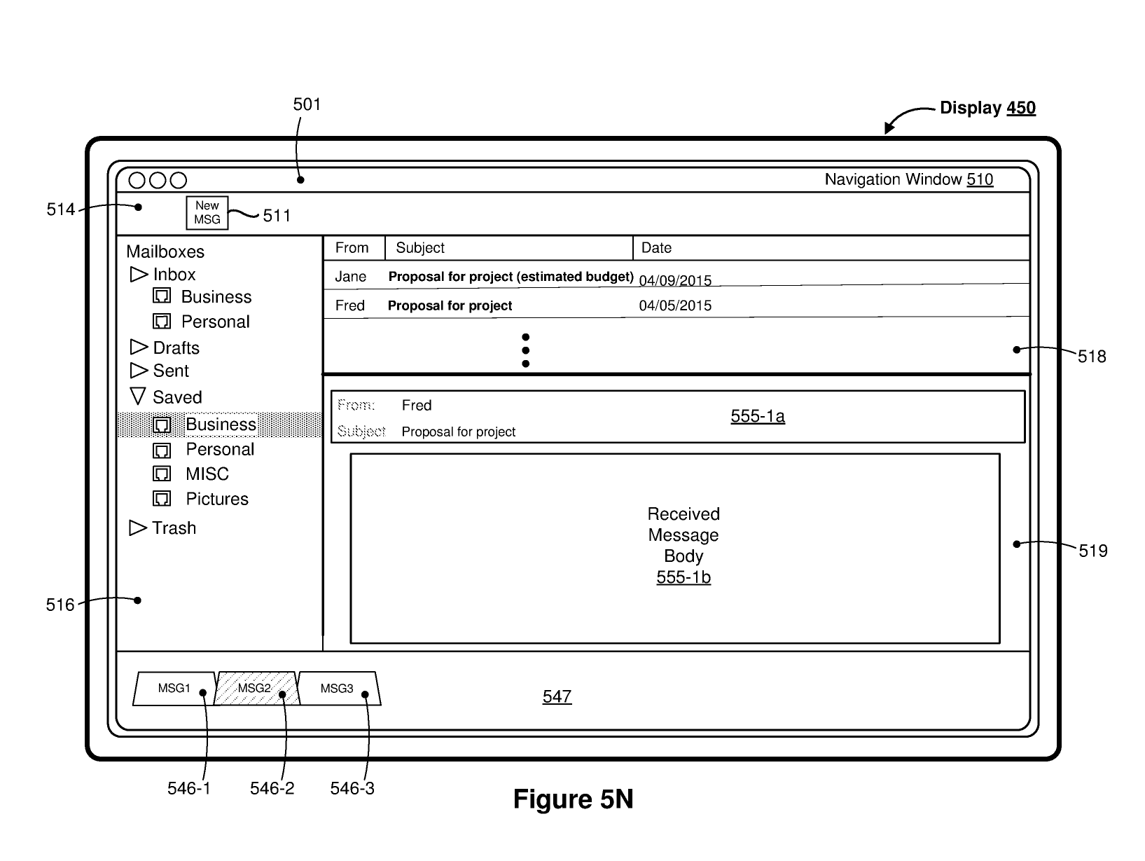

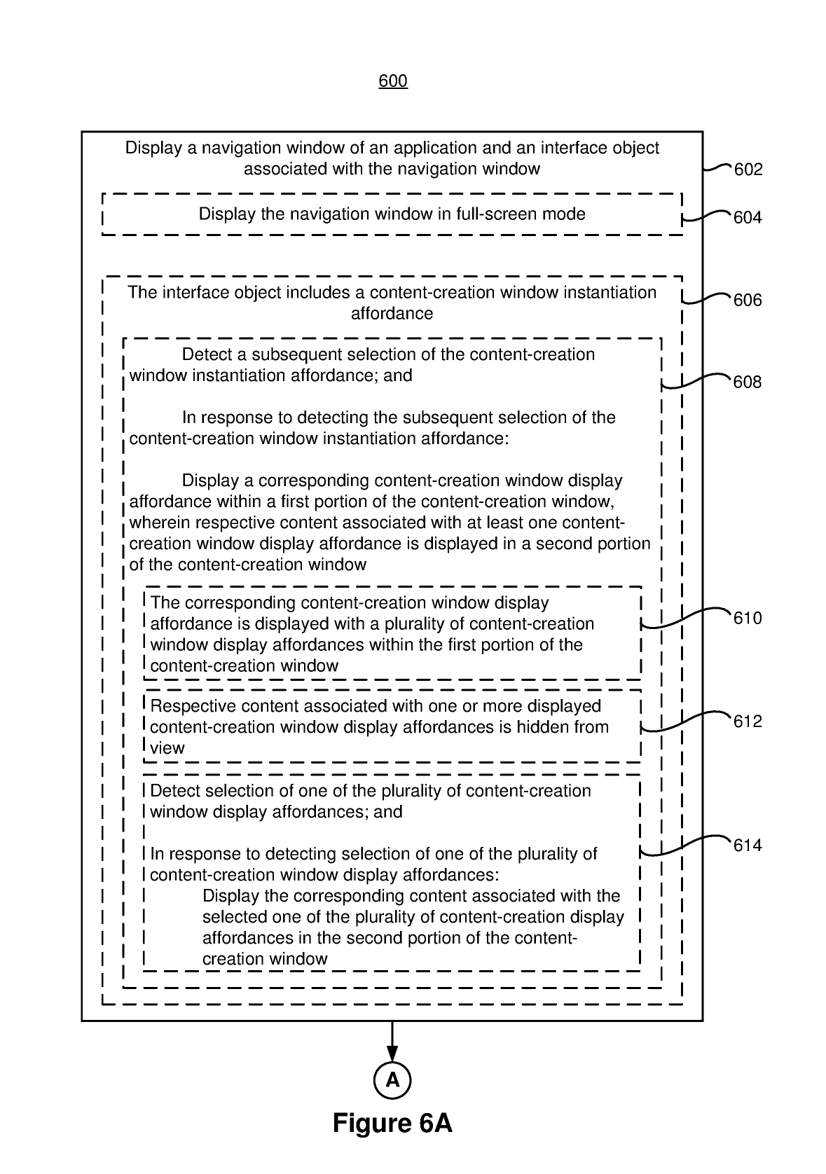

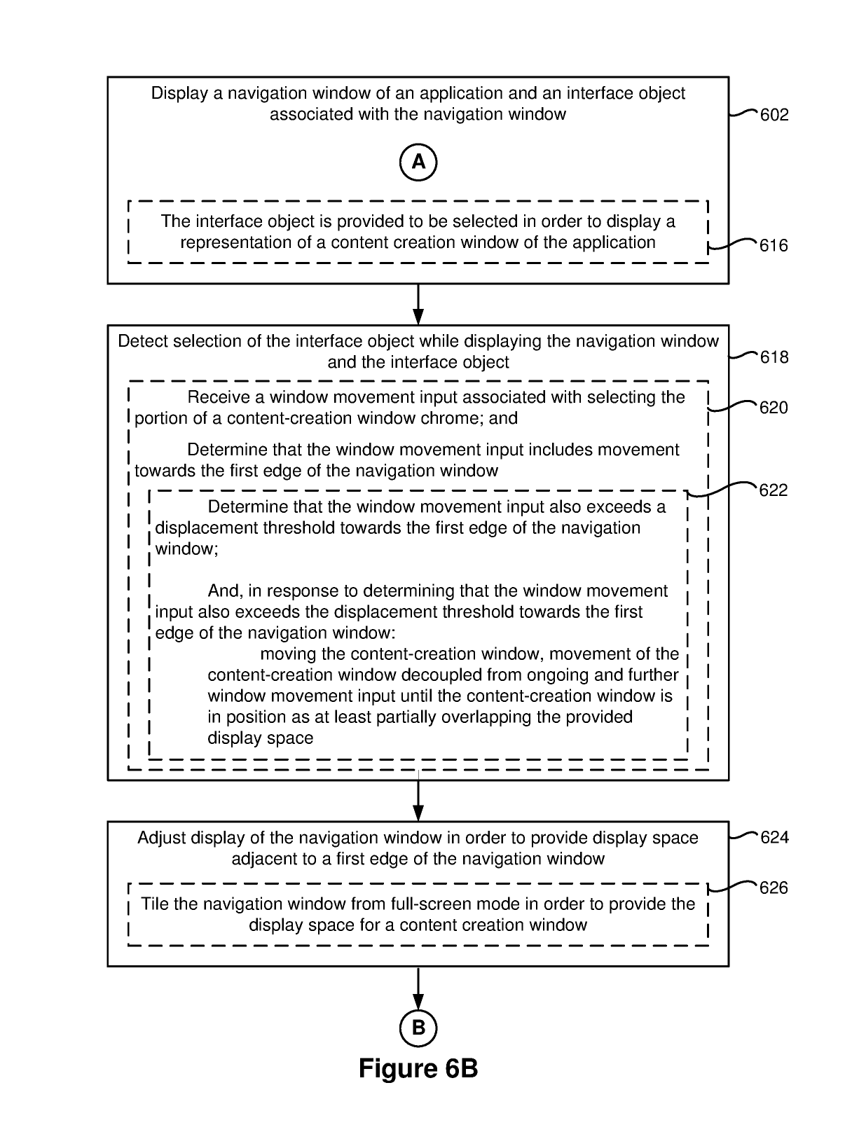

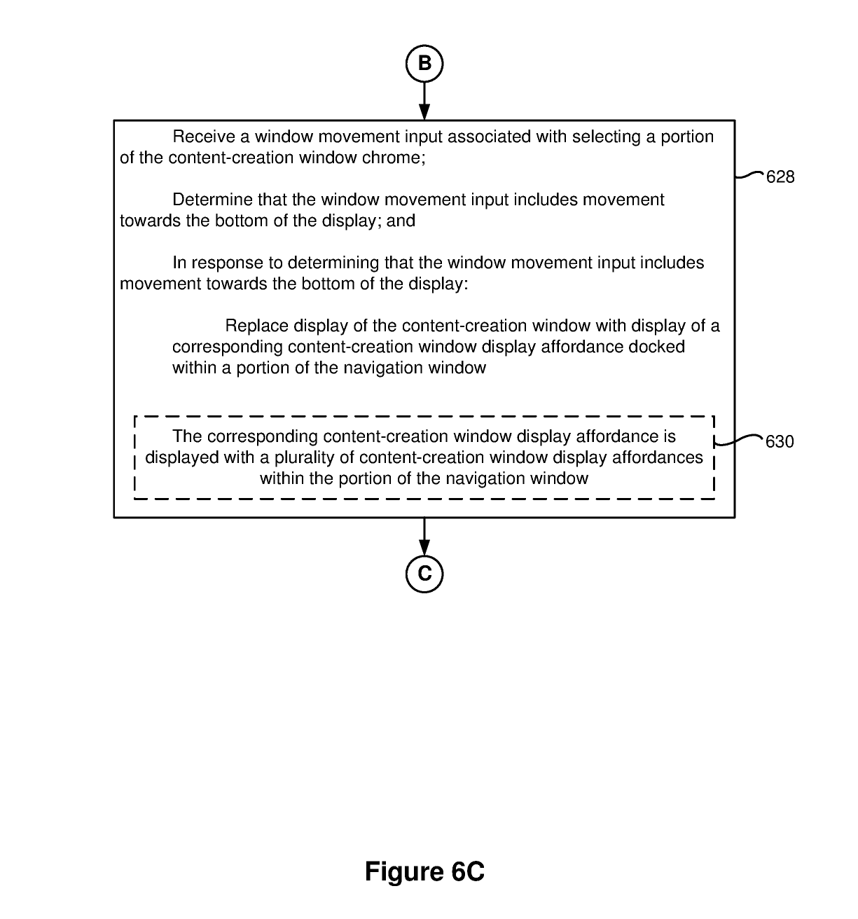

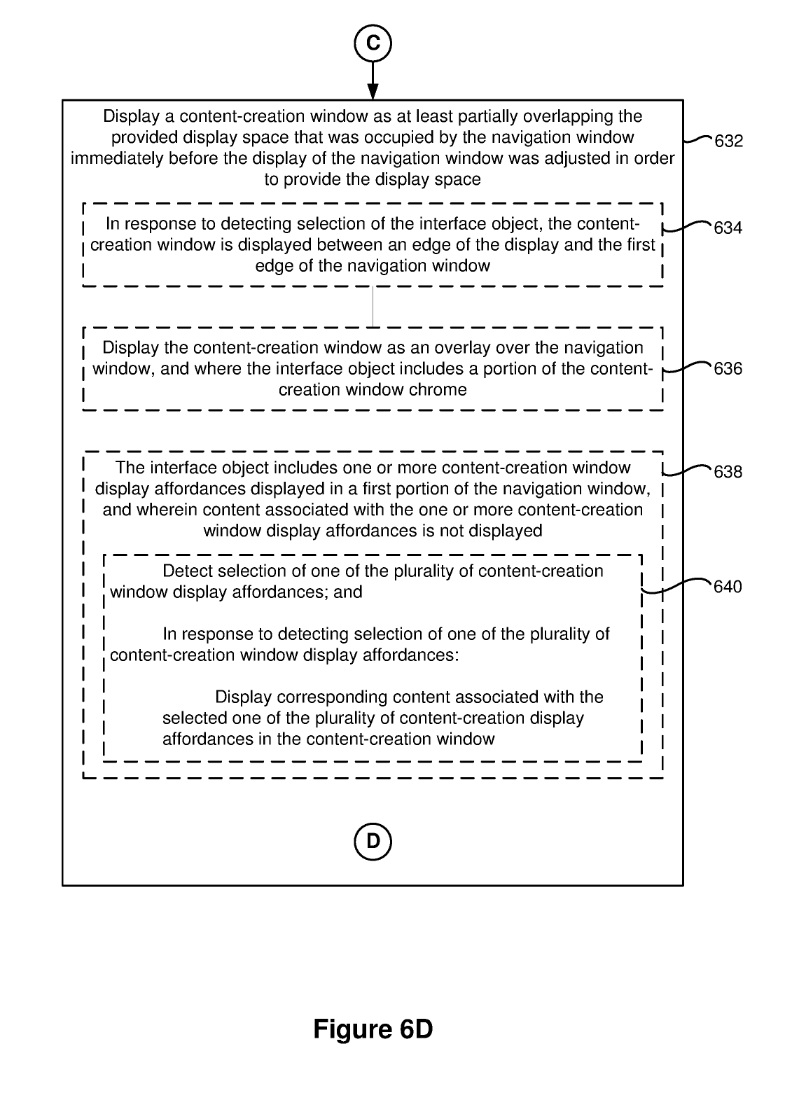

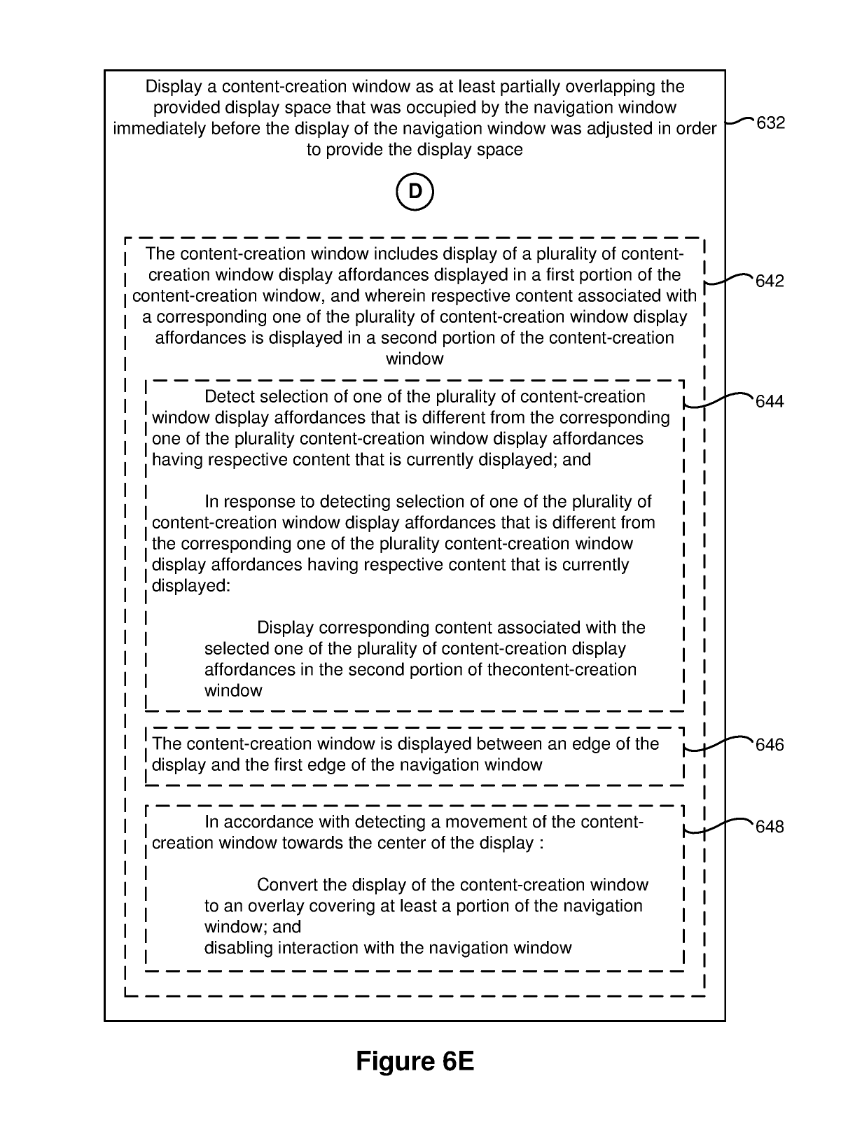

Below, FIGS. 1A-1B, 2, and 3 provide a description of exemplary devices. FIGS. 4A-4B and 5A-5N illustrate exemplary user interfaces for manipulating related windows of an application and/or related tiled windows of the application in accordance with some embodiments. FIGS. 6A-6E are flow diagrams illustrating a method of manipulating related windows of an application and/or related tiled windows of the application in accordance with some embodiments. The user interfaces in FIGS. 5A-5N are used to illustrate the processes in FIGS. 6A-6E.

### Exemplary Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPHONE, and iPAD devices from Apple Inc. of Cupertino, Calif. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer with a touch-sensitive surface (e.g., a touch screen display and/or a touch pad).

In the discussion that follows, an electronic device that includes a display and a touch-sensitive surface is described. It should be understood, however, that the electronic device optionally includes one or more other physical user interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU(s)) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts, for example, on touch-sensitive display 112 of device 100. Device 100 optionally includes one or more tactile output generators 167 for generating tactile output(s), for example, on touch-sensitive display 112 of device 100 or touchpad 355 of device 300. These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, for example, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. CPU(s) 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, which are sometimes also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN), a metropolitan area network (MAN), and/or a wide area network (WAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), space division multiple access (SDMA), Bluetooth or Bluetooth low energy, Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

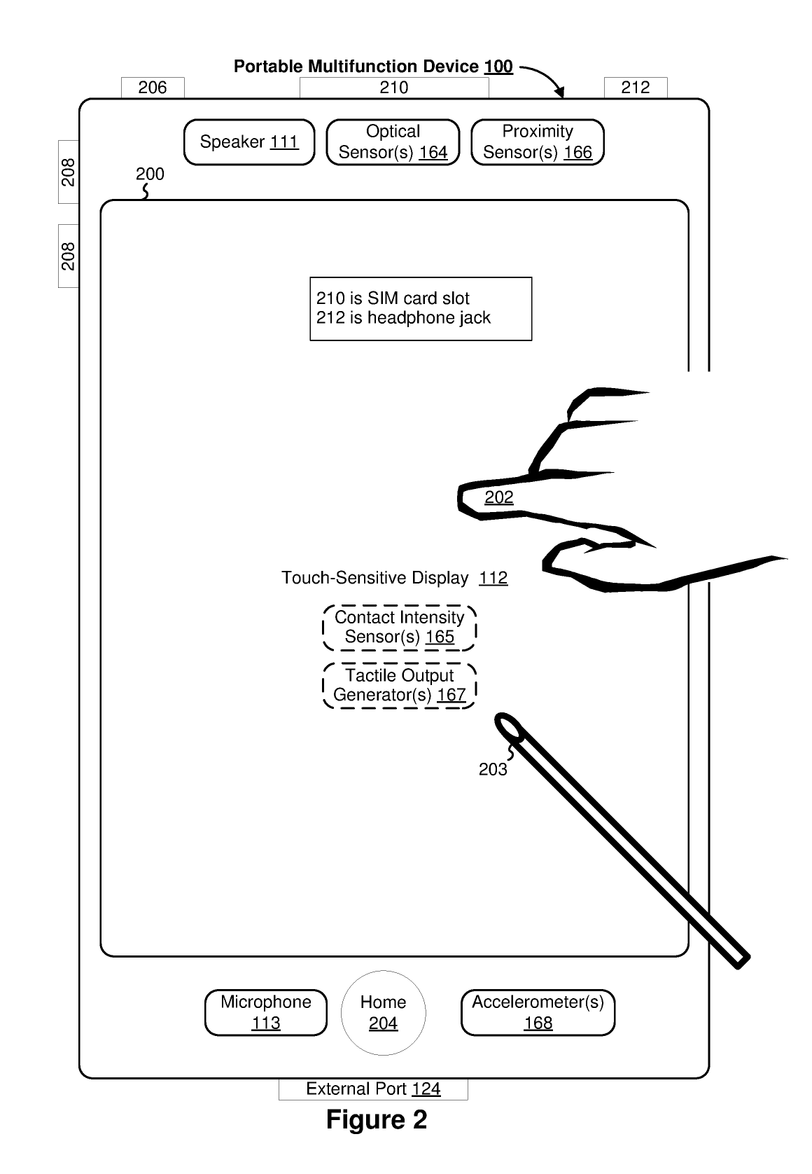

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., jack 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display 112 and other input or control devices 116, to peripherals interface 118. I/O subsystem 106 optionally includes display controller 156, optical sensor(s) controller 158, intensity sensor(s) controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, one or more other input controllers 160 are, optionally, coupled to any (or none) of the following: a keyboard, infrared port, USB port, and a pointer device such as a mouse. The one or more buttons (e.g., button 208, FIG. 2) optionally include an up/down button for volume control of speaker 111 and/or microphone 113. The one or more buttons optionally include a push button (e.g., button 206, FIG. 2).

Touch-sensitive display 112 provides an input interface and an output interface between device 100 and a user. Display controller 156 receives and/or sends electrical signals from/to touch-sensitive display 112. Touch-sensitive display 112 displays visual output to the user. The visual output optionally includes graphics, text, icons, video, and any combination thereof (collectively termed “graphics”). In some embodiments, some or all of the visual output corresponds to user interface objects or elements.

Touch-sensitive display 112 has a sensor or set of sensors that accept input from the user based on detected user contacts. Touch-sensitive display 112 and display controller 156 (along with any associated modules and/or sets of instructions in memory 102) detect contact (and any movement or breaking of the contact) on touch-sensitive display 112 and convert the detected contact into interaction with user interface objects (e.g., one or more soft keys, icons, web pages or images) that are displayed on touch-sensitive display 112. In an exemplary embodiment, a point of contact between touch-sensitive display 112 and the user corresponds to a finger of the user.

Touch-sensitive display 112 optionally uses LCD (liquid crystal display) technology, LPD (light emitting polymer display) technology, or LED (light emitting diode) technology, although other display technologies are used in other embodiments. Touch-sensitive display 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display 112. In an exemplary embodiment, projected mutual capacitance sensing technology is used, such as that found in the iPHONE and iPAD from Apple Inc. of Cupertino, Calif.

Touch-sensitive display 112 optionally has a video resolution in excess of 200 pixels-per-inch (PPI). In some embodiments, the touch screen has a video resolution of approximately 300 PPI. The user optionally makes contact with touch-sensitive display 112 using any suitable object or digit, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch-sensitive display 112, device 100 optionally includes a touchpad (not shown) for activating or deactivating particular functions. In some embodiments, the touchpad is a touch-sensitive area of the device that, unlike touch-sensitive display 112, does not display visual output. The touchpad is, optionally, a touch-sensitive surface that is separate from touch-sensitive display 112 or an extension of the touch-sensitive surface formed by touch-sensitive display 112.

Device 100 also includes power system 162 for powering the various components. Power system 162 optionally includes a power management system, one or more power sources (e.g., a battery), a recharging system, a power failure detection circuit, a power converter or inverter, a power status indicator (e.g., a light-emitting diode (LED)), and any other components associated with the generation, management and distribution of power in portable devices.

Device 100 optionally also includes one or more optical sensors 164, which, in some embodiments, are coupled to optical sensor(s) controller 158 in I/O subsystem 106. One or more optical sensors 164 optionally include charge-coupled device (CCD) or complementary metal-oxide semiconductor (CMOS) phototransistors. One or more optical sensors 164 receive light from the environment, projected through one or more lens, and converts the light to data representing an image. In conjunction with imaging module 143 (also called a camera module), one or more optical sensors sensor 164 optionally capture still images or video. In some embodiments, an optical sensor is located on the back of device 100, opposite touch-sensitive display 112 on the front of device 100, so that the touch screen display is enabled for use as a viewfinder for still and/or video image acquisition. In some embodiments, another optical sensor is located on the front of device 100 so that the user's image is, optionally, obtained for videoconferencing while the user views the other video conference participants on touch-sensitive display 112.

Device 100 optionally also includes one or more contact intensity sensors 165, which, in some embodiments, are coupled to intensity sensor(s) controller 159 in I/O subsystem 106. One or more contact intensity sensors 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). One or more contact intensity sensors 165 receive contact intensity information (e.g., pressure information or a proxy for pressure information) from the environment. In some embodiments, at least one of the one or more contact intensity sensors 165 is collocated with, or proximate to, a touch-sensitive surface (e.g., touch-sensitive display 112 or a touchpad). In some embodiments, at least one contact intensity sensor is located on the back of device 100, opposite touch-sensitive display 112 which is located on the front of device 100.

Device 100 optionally also includes one or more proximity sensors 166, which, in some embodiments, are coupled to peripherals interface 118. Alternately, one or more proximity sensors 166 are coupled to one or more other input controllers 160 in I/O subsystem 106. In some embodiments, one or more proximity sensors 166 turn off and disable touch-sensitive display 112 when the multifunction device is placed near the user's ear (e.g., when the user is making a phone call).

Device 100 optionally also includes one or more tactile output generators 167, which, in some embodiments, are coupled to haptic feedback controller 161 in I/O subsystem 106. One or more tactile output generators 167 optionally include one or more electroacoustic devices, such as speakers or other audio components, and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). One or more contact tactile output generators 167 receive tactile feedback generation instructions from haptic feedback module 133 and generate tactile outputs on device 100 that are capable of being sensed by a user of device 100. In some embodiments, at least one of the one or more tactile output generators 167 is collocated with, or proximate to, a touch-sensitive surface (e.g., touch-sensitive display 112 or a touchpad) and, optionally, generates a tactile output by moving the touch-sensitive surface vertically (e.g., in/out of a surface of device 100) or laterally (e.g., back and forth in the same plane as a surface of device 100). In some embodiments, at least one of the one or more tactile output generators 167 is located on the back of device 100, opposite touch-sensitive display 112 which is located on the front of device 100.

Device 100 optionally also includes one or more accelerometers 168, which, in some embodiments, are coupled to peripherals interface 118. Alternately, one or more accelerometers 168 are, optionally, coupled to one or more other input controllers 160 in I/O subsystem 106. In some embodiments, information is displayed on touch-sensitive display 112 in a portrait view or a landscape view based on an analysis of data received from the one or more accelerometers. Device 100 optionally includes, in addition to accelerometer(s) 168, a magnetometer (not shown) and a Global Positioning System (GPS) (or GLONASS or other global navigation system) receiver (not shown) for obtaining information concerning the location and orientation (e.g., portrait or landscape) of device 100.

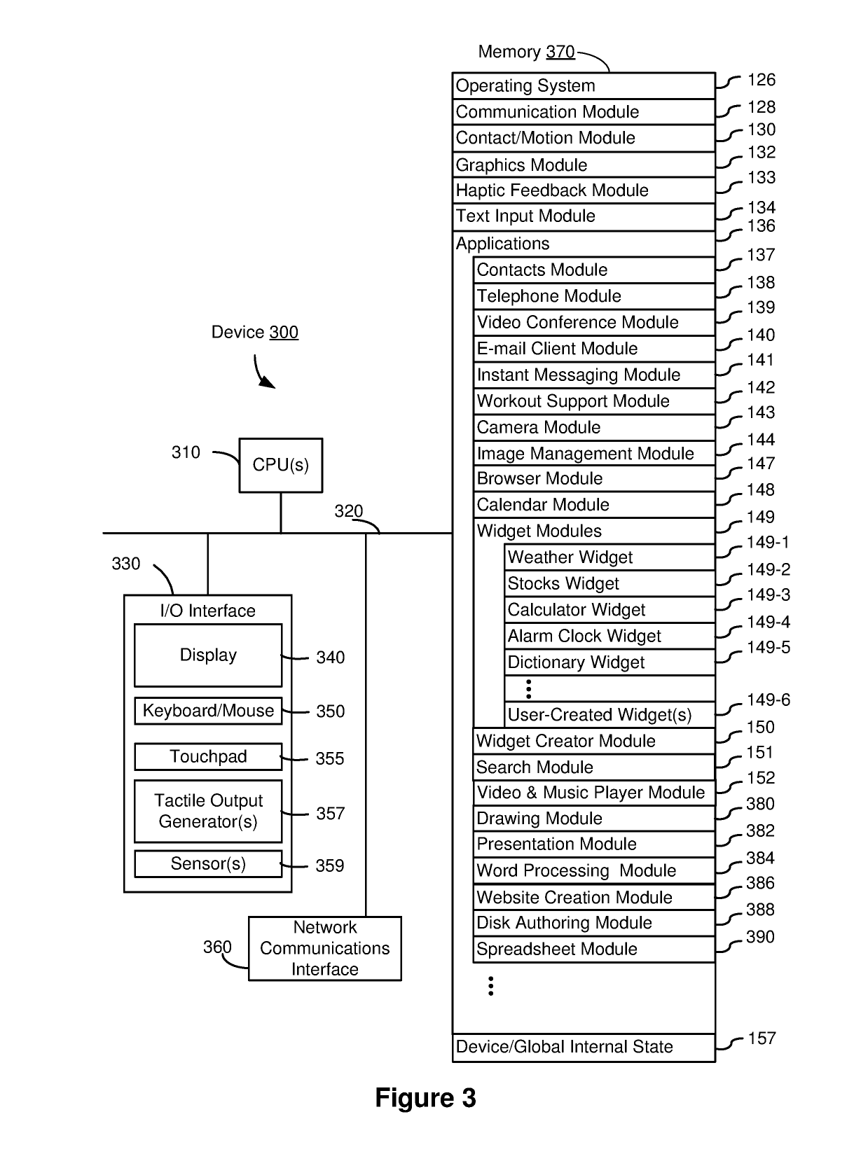

In some embodiments, the software components stored in memory 102 include operating system 126, communication module (or set of instructions) 128, contact/motion module (or set of instructions) 130, graphics module (or set of instructions) 132, text input module (or set of instructions) 134, GPS module (or set of instructions) 135, and applications (or sets of instructions) 136. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display 112; sensor state, including information obtained from the device's various sensors and other input or control devices 116; and location information concerning the device's location and/or attitude.

Operating system 126 (e.g., LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, LIGHTNING, etc.) is adapted for coupling directly to other devices or indirectly over a network (e.g., the Internet, wireless LAN, etc.).

Contact/motion module 130 optionally detects contact with touch-sensitive surface(s) of device 100 such as touch-sensitive display 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface(s) (e.g., detecting one or more finger-dragging events), and determining if the contact has ceased (e.g., detecting a finger-up event or a break in contact). Contact/motion module 130 receives contact data from the touch-sensitive surface(s) (e.g., touch-sensitive display 112 and/or a touchpad). Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch” or multiple finger contacts).

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a touchpad or touch screen can be set to any of a large range of predefined thresholds values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface(s) (e.g., touch-sensitive display 112 or a touchpad) have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event.

Graphics module 132 includes various known software components for rendering and displaying graphics on touch-sensitive display 112 or other display(s), including components for changing the visual impact (e.g., brightness, transparency, saturation, contrast or other visual property) of graphics that are displayed. As used herein, the term “graphics” includes any object that can be displayed to a user, including without limitation text, web pages, icons (such as user interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by one or more tactile output generators 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list) for managing an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth;
telephone module 138 for entering a sequence of characters corresponding to a telephone number, accessing one or more telephone numbers in address book 137, modifying a telephone number that has been entered, dial a respective telephone number, conducting a conversation, and/or disconnecting or hanging up when the conversation is completed using any of a plurality of communications standards, protocols and technologies;
video conferencing module 139 for initiating, conducting, and/or terminating a video conference between a user and one or more other participants in accordance with user instructions;
e-mail client module 140 for creating, sending, receiving, and/or managing e-mail in response to user instructions, which in some circumstances include still or video images taken with camera module 143;
instant messaging (IM) module 141 for entering a sequence of characters corresponding to an instant message, modifying previously entered characters, transmitting a respective instant message (e.g., using a Short Message Service (SMS) or Multimedia Message Service (MMS) protocol for telephony-based instant messages or using XMPP, SIMPLE, or IMPS for Internet-based instant messages), receiving instant messages, and/or viewing received instant messages;
workout support module 142 for creating workouts (e.g., with time, distance, and/or calorie burning goals), communicating with workout sensors (sports devices), receive workout sensor data, calibrating sensors used to monitor a workout, selecting and playing music for a workout, and/or displaying, storing, and transmitting workout data;
camera module 143 for capturing still images or video (including a video stream) and storing them into memory 102, modifying characteristics of a still image or video, and/or deleting a still image or video from memory;
image management module 144 for arranging, modifying (i.e., edittng), or otherwise manipulating, labeling, deleting, presenting (e.g., in a digital slide show or album), and/or storing still and/or video images;
browser module 147 for browsing the Internet in accordance with user instructions, including searching, linking to, receiving, and displaying web pages or portions thereof, as well as attachments and other files linked to web pages;
calendar module 148 for creating, displaying, modifying, and storing calendars and data associated with calendars (e.g., calendar entries, to do lists, etc.) in accordance with user instructions;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151 for searching for text, music, sound, image, video, and/or other files in memory 102 that match one or more search criteria (e.g., one or more user-specified search terms) in accordance with user instructions;
video and music player module 152 for downloading and playing back recorded music and other sound files stored in one or more file formats, such as MP3 or AAC files, and for displaying, presenting, or otherwise playing back videos on touch-sensitive display 112 or on an external, connected display via external port 124);
notes module 153 for creating and managing notes, to do lists, and the like in accordance with user instructions;
map module 154 for receiving, displaying, modifying, and storing maps and data associated with maps (e.g., driving directions; data on stores and other points of interest at or near a particular location; and other location-based data) in accordance with user instructions; and/or
online video module 155 for enabling the user of device 100 to access, browse, receive (e.g., by streaming and/or download), play back (e.g., on sensitive display 112 or on an external, connected display via external port 124), send an e-mail with a link to a particular online video, and otherwise manage online videos in one or more file formats, such as H.264.

Examples of other applications 136 that are, optionally, stored in memory 102 include other word processing applications, other image editing applications, drawing applications, presentation applications, JAVA-enabled applications, encryption, digital rights management, voice recognition, and voice replication.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the “menu button” is a physical push button or other physical input control device instead of a touchpad.

FIG. 1B is a block diagram illustrating exemplary components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 136 or 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or sensor(s) such as one or more proximity sensors 166, one or more accelerometers 168, and/or microphone 113 (through audio circuitry 110). Information that peripherals interface 118 receives from I/O subsystem 106 includes information from touch-sensitive display 112 or another touch-sensitive surface such as a touchpad.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (i.e., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and lift-off of the touch (touch end). In some embodiments, the event also includes information for one or more associated event handlers 190.

In some embodiments, event definition 187 includes a definition of an event for a respective user interface object. In some embodiments, event comparator 184 performs a hit test to determine which user interface object is associated with a sub-event. For example, in an application view in which three user interface objects are displayed on touch-sensitive display 112, when a touch is detected on touch-sensitive display 112, event comparator 184 performs a hit test to determine which of the three user interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module 145. In some embodiments, object updater 177 creates and updates objects used in application 136-1. For example, object updater 176 creates a new user interface object or updates the position of a user interface object. GUI updater 178 updates the GUI. For example, GUI updater 178 prepares display information and sends it to graphics module 132 for display on a touch-sensitive display 112.

In some embodiments, event handler(s) 190 include or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive surfaces also applies to other forms of user inputs to operate portable multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch-sensitive display 112 (sometimes also herein called a “touch screen”) in accordance with some embodiments. Touch-sensitive display 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application in a set of applications 136 (FIG. 1) that are, optionally executed on device 100. Alternatively, in some embodiments, the menu button is implemented as a soft key in a GUI displayed on touch-sensitive display 112.

In one embodiment, device 100 includes touch-sensitive display 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch-sensitive display 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a wearable device, a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU(s)) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen. I/O interface 330 also optionally includes a keyboard and/or mouse (or other pointing device) 350 and touchpad 355, tactile output generator 357 for generating tactile outputs on device 300 (e.g., similar to one or more tactile output generators 167 described above with reference to FIG. 1A), and sensors 359 (e.g., optical, acceleration, proximity, touch-sensitive, and/or contact intensity sensor(s) similar to the ones described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while, in some embodiments, memory 102 of portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that is, optionally, implemented on portable multifunction device 100.

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, also referred to as iPOD (trademark of Apple Inc.) module 152, labeled “iPod”; and
Icons for other applications, such as:
   Icon 424 for IM module 141, labeled “Text;”
   Icon 426 for calendar module 148, labeled “Calendar;”
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Map”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely exemplary. For example, icon 422 for video and music player module 152 are labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a touchpad) that is separate from the display 450. Device 300 also, optionally, includes one or more tactile output generators 357 for generating tactile output(s) and/or one or more contact intensity sensors (e.g., one or more of sensors 359, FIG. 3) for detecting intensity of contacts on touch-sensitive surface 451.

Some of the examples which follow will be given with reference to inputs on an input device, such as a mouse or a touch-sensitive surface (e.g., a touch pad), that is separate from the display 450 (e.g., as shown in FIG. 4B). Alternatively, in some embodiments, the device detects inputs on a touch-sensitive display 112 (sometimes also herein called a “touch screen”), where the touch-sensitive surface and the display are combined. In some embodiments the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to inputs from an input device (e.g., mouse, touchpad, or stylus-based inputs with a focus selector such as a cursor), it should be understood that, in some embodiments, the inputs are replaced with finger inputs (e.g., finger contacts, finger tap gestures, finger swipe gestures, and the like). For example, a mouse click is, optionally, replaced with a swipe gesture (e.g., instead of a contact) followed by movement of the contact the contact along the path of the cursor (e.g., instead of movement of the cursor). As another example, a mouse click is, optionally, replaced with a tap gesture where detection of the contact over the location is followed by ceasing to detect the contact (e.g., instead of detection of up-click or down-click while the cursor is located over the location).

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch screen (e.g., touch-sensitive display 112 in FIGS. 1A and 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input.

In some implementations, focus is moved from one region of a user interface to another region of the user interface without corresponding movement of a cursor or movement of a contact on a touch-screen display (e.g., by using a tab key or arrow keys to move focus from one button to another button). In these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

### User Interfaces and Associated Processes

Attention is now directed towards embodiments of user interfaces (“UI”) and associated processes that may be implemented on an electronic device with a display and a touch-sensitive surface, such as device 300 or portable multifunction device 100.

FIGS. 5A-5N illustrate exemplary user interfaces for manipulating related windows of an application and/or related tiled windows of the application in accordance with some embodiments. The user interfaces in these figures are used to illustrate the process described below in FIGS. 6A-6E.

As shown in FIG. 5A-5N, a device (e.g., device 300, FIG. 3) displays a user interface with a plurality of user-interface elements and a focus selector 502 on display 450. In some embodiments, focus selector 502 (sometimes also referred to as a “cursor”) is controlled by an input device that is separate from display 450 such as a mouse, stylus, motion sensing input device, speech command processing device, touchpad, or the like. In some embodiments, the user interface includes a dock 504 with a plurality of dock icons 506-A, 506-B, and 506-C corresponding to a number of applications.

In FIG. 5A, the user interface includes a navigation window 510 with a first edge 515. Navigation window 510 has a first display width 520. For example, navigation window 510 is associated with an email application. In accordance with some embodiments, navigation window 510 includes a first pane 516 and a second pane 518. As shown in FIG. 5A, each of first and second panes 516, 518 within navigation window 510 include a plurality of user interface elements (e.g., folders, files, or directories, representations of email messages, etc.). As shown in FIG. 5A, first pane 516 includes a plurality of folder locations (e.g., Inbox, Drafts, Sent (mail), Saved/Business, Saved/Personal, Saved/MISC, Saved/Pictures, etc.). For example, the “Saved/Business” folder location is currently selected within first pane 516. As shown in FIG. 5A, second pane 518 includes a plurality of representations of email messages associated with the currently selected “Saved/Business” directory location (none of which are shown as selected in FIG. 5A). In some embodiments, navigation window 510 includes a chrome area 501 by which navigation window 510 may be dragged and repositioned on display 450. In some embodiments, chrome area 501 includes a set of controls, toggles, and/or affordances. Additionally, in some embodiments, navigation window 510 includes a user interface region 514 with additional controls, toggles, and/or affordances. For example, user interface region 514 is placed above first and second panes 516, 518, and includes a content-creation window instantiation affordance 511 (e.g., a “compose new email message” button or the like).

FIGS. 5A-5C illustrate a sequence in which display of one or more content-creation windows are added in combination with display of a navigation window, in response to detecting selection of an interface object (e.g., affordance 511).

FIG. 5A, navigation window 510 is displayed without an associated content-creation window. In some embodiments, content-creation window instantiation affordance 511, when activated using focus selector 502 (e.g., with a single or double click), causes the instantiation and display of a new content-creation window, which may be displayed as overlapping at least a portion of navigation window 510.

For example, as shown in FIG. 5B, a content-creation window 540 is instantiated and displayed as at least partially overlapping navigation window 510. In some embodiments, content-creation window 540 includes a first pane 542 having a first input field 542-1a and a second input field 542-1b provided for user content-creation associated with drafting an email. For example, first input field 542-1a is provided for one or more email addresses and an email subject, and second input field 542-1b is provided as a composition space (for a draft message body) in which a user can enter text, images, and/or video clips as a part of an email message. In some embodiments, content-creation window 540 includes a chrome area 541 by which content-creation window 540 may be dragged. In some embodiments, chrome area 541 includes a set of controls, toggles, and/or affordances.

Continuing the example, activating content-creation window instantiation affordance 511 again causes the instantiation and display of another new content-creation window, which may be displayed as overlapping at least a portion of navigation window 510 and/or a portion of content-creation window 540. For example, as shown in FIG. 5C, a second content-creation window 545 is instantiated and displayed as at least partially overlapping navigation window 510 and content-creation window 540. Similar, to content-creation window 540, content-creation window 545 has a first input field 542-2a and a second input field 542-2b provided for user content-creation associated with drafting an email. For example, first input field 542-2a is provided for one or more email addresses and an email subject, and second input field 542-2b is provided as a composition space (for a draft message body) in which a user can enter text, images, and/or video clips as a part of an email message. In some embodiments, second content-creation window 545 includes a chrome area 543 by which content-creation window 545 may be dragged. In some embodiments, chrome area 543 includes a set of controls, toggles, and/or affordances.

FIGS. 5A, 5D-5F illustrate a sequence in which display of a navigation window is adjusted and a related content-creation window is displayed together with the navigation window, in response to detecting selection of an interface object (e.g., affordance 511). Again, In FIG. 5A, navigation window 510 is displayed without an associated content-creation window. In some embodiments, content-creation window instantiation affordance 511, when activated using focus selector 502 (e.g., with a single or double click), causes display of navigation window 510 to be adjusted. With reference to FIGS. 5A and 5D, display of navigation window 510 is adjusted so that first display width 520 is reduced to a second display width 521, and a display space 530 is exposed, which was occupied by navigation window 510 immediately before activation of content-creation window instantiation affordance 511. Display space 530 has a third display width of 522. In some embodiments, the combination of second display width 521 and third display width 522 is at least approximately equal to first display width 520. Moreover, in some embodiments, as shown by comparison of FIGS. 5A and 5D, navigation window 510 is adjusted by moving first edge 515 of navigation window 510 to the left as indicated by direction line 505, and thus reducing the respective display width of second pane 518 without reducing the respective display width of first pane 516. In some embodiments, the respective display widths of first and second panes 516, 518 are reduced proportionally. In some embodiments, the respective display width of first pane 516 is reduced without reducing the respective display width of second pane 518.

Subsequently and/or almost immediately, as shown in FIG. 5E, a content-creation window 540 (e.g., new email composition window) is displayed as at least partially overlapping display space 530 and adjacent to first edge 515 of navigation window 510. Moreover, while FIG. 5D illustrates display of navigation window 510 together with empty display space 530, in some embodiments, a display transition between the representations illustrated in FIGS. 5A and 5E is practically immediate and does not include a prolonged display of display space 530, if at all, after activation of content-creation window instantiation affordance 511. In other words, empty display space 530 is not displayed in accordance with some embodiments. As such, those of ordinary skill in the art will appreciate from the present disclosure that FIG. 5D has been provided for illustrative purposes and is not to be considered as limiting the appended claims. Moreover, content-creation window 540 shown in Figure SE is similar to and adapted from content-creation window 540 shown in FIG. 5B. Accordingly, elements common to each have common reference numbers, and thus, the detailed description of content-creation window 540 provided above is not reiterated here for the sake of brevity.

The transition from FIG. 5E to FIG. 5F illustrates a portion of the sequence in which content-creation window 540, displayed together with navigation window 510, is modified to include two or more selectable message tabs (or content-creation display affordances) in response to corresponding subsequent activations of content-creation window instantiation affordance 511. As shown in FIG. 5E, content-creation window 540 is displayed together with navigation window 540 after a first activation of content-creation window instantiation affordance 511 (as just described above). In some embodiments, the plurality of content-creation window display affordances are arranged adjacent to one another. Multiple new messages are delineated and selectable by tabs in the message pane, such that selection of a particular tab displays a corresponding composition space for a respective new message (as well as recipient and sender fields, and a subject line.). For example, FIG. 5F illustrates the display of content-creation window 540 after two subsequent activations of content-creation window instantiation affordance 511 using focus selector 502. As compared to FIG. 5E, content-creation window 540 in FIG. 5F includes a user interface region 546 (e.g., a tabbed message pane) having three message tabs 546-1, 546-2, 546-3 (e.g., content-creation window display affordances, also labeled “MSG1,” “MSG2,” “MSG3”) associated with three draft email messages that have been generated in response to the three activations of content-creation window instantiation affordance 511. Each message tab 546-1, 546-2, 546-3 is a content-creation window display affordance for a particular draft email message, that when selected causes display of content associated the corresponding particular draft email message. More specifically, in some embodiments, selection of a particular one of the message tabs 546-1, 546-2, 546-3 causes display of respective input fields associated with the corresponding draft email message in first pane 542. For example, as shown in FIG. 5F, focus selector 502 is used select message tab 546-2 (“MSG2”), which causes display, in first pane 542, of a respective first input field 542-2b and a respective second input field 542-3b associated with the corresponding second draft email message. Similar to FIG. 5E, in some embodiments, first input field 542-2a is provided for one or more email addresses and an email subject, and second input field 542-2b is provided as a composition space (for a draft message body) in which a user can enter text, images, and/or video clips as a part of an email message for “MSG2.” Additionally, corresponding content and input fields associated with message tabs 546-1 (“MSG1”) and 546-3 (“MSG3”) are hidden from view.

Briefly, FIGS. 5A and 5G illustrate a sequence in which display of a navigation window is adjusted from a (partial-screen) windowed mode to a full-screen mode. As shown in FIGS. 5A and 5G, chrome area 501 of navigation window 510 includes a window tiling affordance 509. Starting with (partial-screen) navigation window 510 in FIG. 5A, activation of window tiling affordance 509 causes navigation window 510 to change to a full-screen tiled navigation window 510 (e.g., as shown in FIG. 5G) that occupies all of a window display area on display 450.

FIG. 5G is similar to and adapted from FIG. 5A. Elements common to FIGS. 5A and 5G include common reference numbers, and only the differences between FIGS. 5A and 5G are described herein for the sake of brevity. To that end, as a new example shown in FIG. 5G, navigation window 510 is displayed in full-screen mode as full-screen tiled navigation window 510, which occupies all of a window display area on display 450. In various embodiments, a full-screen tiled window (e.g., full-screen tiled navigation window 510) occupies an area of a display that is designated for displaying application windows, which typically includes a majority of the area of the display but, in some embodiments, excludes one or more regions that are designated for displaying system information such as a status bar, a task bar, or a menu bar.

Additionally, in some embodiments, full-screen tiled navigation window 510 includes a third pane 519. As an example, when full-screen tiled navigation window 510 is associated with an email application as discussed above, third pane 519 is provided to display a selected received email message. To that end, third pane 519 includes an address and subject field 555-1a and a received message body field 555-1b, which includes the content associated with a particular email message.

FIGS. 5G-5J illustrate a sequence in which display of a full-screen tiled navigation window is changed to a partial-screen tiled navigation window, and a related partial-screen tiled content-creation window is displayed together with the partial-screen tiled navigation window, in response to detecting selection of an interface object (e.g., affordance 511). In a similar manner to the example detailed above, content-creation window instantiation affordance 511, when activated using focus selector 502 (e.g., with a single or double click), causes display of full-screen tiled navigation window 510 (shown in FIG. 5G) to be changed to partial-screen tiled navigation window 510 (shown in FIG. 5H). That is, display of full-screen tiled navigation window 510 is adjusted so that the display width is reduced producing partial-screen tiled navigation window 510, and a display space 530 is exposed, which was occupied by full-screen tiled navigation window 510 immediately before activation of content-creation window instantiation affordance 511. In some embodiments, as shown by comparison of FIGS. 5G and 5H, partial-screen tiled navigation window 510 is produced by moving first edge 515 of full-screen tiled navigation window 510 to the left, and thus reducing the respective display widths of second pane 518 and third pane 519 without reducing the respective display width of first pane 516. In some embodiments, the respective display widths of panes 516, 518, 519 are reduced proportionally. In some embodiments, the respective display width of first pane 516 is reduced without reducing the respective display widths of second pane 518 and third pane 519.

Subsequently and/or almost immediately, as shown in FIG. 5I, a partial-screen tiled content-creation window 540 (e.g., new email composition window) is displayed as at least partially overlapping display space 530 and adjacent to first edge 515 of partial-screen tiled navigation window 510. Moreover, while FIG. 5I illustrates display of navigation window 510 together with empty display space 530, in some embodiments, a display transition between the representations illustrated in FIGS. 5H and 5I is practically immediate and does not include a prolonged display of display space 530, if at all, after activation of content-creation window instantiation affordance 511. In other words, empty display space 530 is not displayed in accordance with some embodiments. As such, those of ordinary skill in the art will appreciate from the present disclosure that FIG. 5H has been provided for illustrative purposes and is not to be considered as limiting the appended claims.

Partial-screen tiled content-creation window 540 shown in FIG. 5I is similar to and adapted from content-creation window 540 shown in FIG. 5E. Accordingly, elements common to each have common reference numbers, and thus, the detailed description of content-creation window 540 provided above is not reiterated here for the sake of brevity. Additionally, in some embodiments, instead of reducing full-screen tiled navigation window 510 to a partial-screen tiled navigation window 510 in order to display partial-screen tiled content-creation window 540, a composition pane is added to full-screen tiled navigation window 510. In various embodiments, a composition pane is added to full-screen tiled navigation window 510 in a similar manner to the way in which partial-screen tiled content-creation window 540 is added as described above. However, instead of reducing the display width of full-screen tiled navigation window 510, one or more of the panes within full-screen tiled navigation window 510 are reduced in size in order to provide room for a composition pane. In some embodiments, at least two of the panes, including the new composition pane, are enabled for active use. In some embodiments, all of the panes are enabled for active use.

Continuing the example, in some embodiments, the transition from FIG. 5I to FIG. 5J illustrates a portion of the sequence in which partial-screen tiled content-creation window 540, displayed together with partial-screen tiled navigation window 510, is modified to include two or more selectable message tabs (or content-creation display affordances) in response to corresponding subsequent activations of content-creation window instantiation affordance 511. As shown in Figure SI, partial-screen tiled content-creation window 540 is displayed together with partial-screen tiled navigation window 540 after a first activation of content-creation window instantiation affordance 511 (as just described above). FIG. 5I illustrates the display of partial-screen tiled content-creation window 540 after two subsequent activations of content-creation window instantiation affordance 511 using focus selector 502.

As compared to Figure SI, partial-screen tiled content-creation window 540 in FIG. 5I includes a user interface region 546 having three message tabs 546-1, 546-2, 546-3 (e.g., content-creation window display affordances, also labeled “MSG1,” “MSG2,” “MSG3”) associated with three draft email messages that have been generated in response to the three activations of content-creation window instantiation affordance 511. Each message tab 546-1, 546-2, 546-3 is a content-creation window display affordance for a particular draft email message, that when selected causes display of content associated the corresponding particular draft email message. In FIG. 5J, message tab 546-3 (“MSG3”) is currently selected because message tab 546-3 corresponds to the last of the three activations of content-creation window instantiation affordance 511. Accordingly, first pane 542 includes display of respective input fields associated with a corresponding third draft email message. For example, as shown, first pane 542 includes display of first input field 542-3a and a respective second input field 542-3b associated with the corresponding third draft email message. Similar to FIG. 5I (and FIG. 5E), in some embodiments, first input field 542-3a is provided for one or more email addresses and an email subject, and second input field 542-3b is provided as a composition space (for a draft message body) in which a user can enter text, images, and/or video clips as a part of an email message for “MSG3.” Additionally, corresponding content and input fields associated with message tabs 546-1 (“MSG1”) and 546-2 (“MSG2”) are hidden from view.

In some embodiments, selection of a particular one of the message tabs 546-1, 546-2, 546-3 causes display of respective input fields associated with the corresponding draft email message in first pane 542. For example, FIG. 5K illustrates a portion of the sequence in which message tab 546-2 (“MSG2”) is selected using focus selector 502. Selection of message tab 546-2 (“MSG2”) causes display, in first pane 542, of a respective first input field 542-2a and a respective second input field 542-1b associated with the corresponding second draft email message Similar to above, in some embodiments, first input field 542-2a is provided for one or more email addresses and an email subject, and second input field 542-2b is provided as a composition space (for a draft message body) in which a user can enter text, images, and/or video clips as a part of an email message for “MSG2.” Additionally, also similar to above, corresponding content and input fields associated with message tabs 546-1 (“MSG1”) and 546-3 (“MSG3”) are hidden from view.

In another example, FIG. 5L illustrates a portion of the sequence in which message tab 546-1 (“MSG1”) is selected using focus selector 502. Selection of message tab 546-1 (“MSG1”) causes display, in first pane 542, of a respective first input field 542-1a and a respective second input field 542-1b associated with the corresponding first draft email message. Similar to above, in some embodiments, first input field 542-1a is provided for one or more email addresses and an email subject, and second input field 542-1b is provided as a composition space (for a draft message body) in which a user can enter text, images, and/or video clips as a part of an email message for “MSG1.” Additionally, also similar to above, corresponding content and input fields associated with message tabs 546-2 (“MSG2”) and 546-3 (“MSG3”) are hidden from view.

Additionally, in some embodiments, dragging chrome area 541 towards the center of display 450 causes partial-screen tiled content-creation window 540 to be displayed as an overlay on full-screen tiled navigation window 510 (as shown in FIG. 5M).

FIGS. 5M-5N illustrate a sequence in which display of both a full-screen tiled navigation window and a partial-screen tiled content-creation window (shown as an overlay) are changed to respective partial-screen tiled windows, in response to a window movement input dragging the partial-screen tiled content-creation window from the overlay position.

FIG. 5M is similar to and adapted from FIGS. 5G and 5J. Elements common to FIGS. 5G, 5J and 5M include common reference numbers, and only the differences between FIGS. 5G, 5J and 5M are described herein for the sake of brevity. To that end, FIG. 5M includes full-screen tiled navigation window 510 as described above with reference to FIG. 5G. Additionally, FIG. 5M includes content-creation window 540 displayed as an overlay over full-screen tiled navigation window 510. In some embodiments, when content-creation window 540 displayed as an overlay, user interaction associated with the full-screen tiled navigation window 510 is substantially disabled (e.g., inputs directed toward the portions of the full-screen tiled navigation window 510 that is still shown are ignored while the content-creation window 540 is displayed as an overlay). In some embodiments, and for illustrative purposes, full-screen tiled navigation window 510 is displayed as faded (or in shadow, etc.) in order to indicate that inputs directed toward the portions of the full-screen tiled navigation window 510 that is still shown are ignored while the content-creation window 540 is displayed as an overlay. As such, a user is forced to interact with content-creation window 540. For example, continuing the email application example introduced above, a user can complete and send the email draft, save the draft for completion at a later time, or delete the draft in order to fully remove display of the partial-screen tiled content-creation window 540.

Additionally, in some embodiments, by dragging chrome area 541 using focus selector 502 partial-screen tiled content-creation window 540 can be moved into a structured arrangement with full-screen tiled navigation window 510. For example, transition to the structured arrangement in FIG. 5J is initiated when chrome area 541 is dragged to the right along direction indicator line 605 using focus selector 502. Responsively, device changes display of full-screen tiled navigation window 510 (shown in FIG. 5M) to partial-screen tiled navigation window 510 (shown in FIG. 5J). In various embodiments, direction indicator line 605 is not visible on display 450, and is provided in FIG. 5M primarily for the sake of illustration. In some embodiments, content-creation window 540 is moved to the final position, adjacent to partial-screen tiled navigation window 510 (shown in FIG. 5J), once content-creation window 540 has been dragged a threshold distance along direction indicator line 605. Once content-creation window 540 has been dragged the threshold distance, content-creation window 540 is then automatically repositioned adjacent first edge 515. In other words, content-creation window 540 snaps to the final position once dragged the threshold distance, without further window movement input needed to manually position content-creation window 540 into the final position shown in FIG. 5J.

In other example, transition to the structured arrangement in FIG. 5N (from FIG. 5M) is initiated when chrome area 541 is dragged to down along direction indicator line 607 using focus selector 502. Responsively, as shown in FIG. 5N, display of partial-screen tiled content-creation window 540 ends, and full-screen tiled navigation window 510 is changed to include a user interface region 547 where message tabs 546-1, 546-2, 546-3, which were previously displayed in partial-screen tiled content-creation window 540, are displayed without the associated content. In some embodiments, selection of one of the message tabs 546-1, 546-2, 546-3 from within user interface region 547 causes the reintroduction of partial-screen tiled content-creation window 540 as an overlay on full-screen tiled navigation window 510 (as shown in FIG. 5M). In some embodiments, selection of one of the message tabs 546-1, 546-2, 546-3 from within user interface region 547 causes the creation of a structured arrangement of partial-screen tiled content-creation window 540 in combination with partial-screen tiled navigation window 510 (as shown in FIG. 5J). To that end, the display width of full-screen tiled navigation window 510 is reduced as described above to produce partial-screen tiled navigation window 510, and user interface region 547 is removed or hidden.

FIGS. 6A-6E are flow diagrams illustrating a method 600 of manipulating related windows of an application and/or related tiled windows of the application in accordance with some embodiments. The method 600 is performed at an electronic device (e.g., device 300, FIG. 3, or portable multifunction device 100, FIG. 1A) with a display and one or more input devices, one or more processors, and a non-transitory memory. Some operations in method 600 are, optionally, combined and/or the order of some operations is, optionally, changed. In another example, various portions of method 600 may be practiced and/or performed in various sequences and/or combinations, including simultaneously.

As described below, the method 600 provides an intuitive way to manipulate related windows of an application and/or related tiled windows of the application. The method reduces the cognitive burden on a user when manipulating related windows of an application and/or related tiled windows of the application, thereby creating a more efficient human-machine interface. For battery-operated electronic devices, enabling a user to manipulate related windows of an application and/or related tiled windows of the application faster and more efficiently conserves power and increases the time between battery charges.

The device displays (602) a navigation window of an application and an interface object associated with the navigation window. For example, in FIG. 5A, the user interface includes a navigation window 510 having a content-creation window instantiation affordance 511 (e.g., a “compose new email message” button or the like). In some embodiments, device displays (604) the navigation window in full-screen mode. For example, in FIG. 5G, navigation window 510 is displayed in full-screen mode as full-screen tiled navigation window 510, which occupies all of a window display area on display 450. In some embodiments, the interface object includes (606) includes a content-creation window instantiation affordance. As noted above, for example, in FIG. 5A, navigation window 510 includes content-creation window instantiation affordance 511 (e.g., a “compose new email message” button or the like).

In some embodiments, the device detects (608) a subsequent selection of the content-creation window instantiation affordance, and in response displays displaying a corresponding content-creation window display affordance (e.g., a message tab) within a first portion of the content-creation window, where respective content associated with at least one content-creation window display affordance is displayed in a second portion of the content-creation window. In some embodiments, the device displays (610) a plurality of content-creation window display affordances within the first portion of the content-creation window. For example, as shown in FIG. 5F, content-creation window 540 includes a user interface region 546 having three message tabs 546-1, 546-2, 546-3 (e.g., content-creation window display affordances, also labeled “MSG1,” “MSG2,” “MSG3”) associated with three draft email messages that have been generated in response to the three activations of content-creation window instantiation affordance 511. Each message tab 546-1, 546-2, 546-3 is a content-creation window display affordance for a particular draft email message, that when selected causes display of content associated the corresponding particular draft email message. More specifically, in some embodiments, selection of a particular one of the message tabs 546-1, 546-2, 546-3 causes display of respective input fields associated with the corresponding draft email message in first pane 542. In some embodiments, the device hides (612) respective content associated with one or more displayed content-creation window display affordances. For example, with continued reference to FIG. 5F, corresponding content and input fields associated with message tabs 546-1 (“MSG1”) and 546-3 (“MSG3”) are hidden from view.

In some embodiments, the device detects (614) selection of one of the plurality of content-creation window display affordances, and in response, displays the corresponding content associated with the selected one of the plurality of content-creation display affordances in the second portion of the content-creation window. For example, as shown in FIG. 5F, focus selector 502 is used select message tab 546-2 (“MSG2”), which causes display, in first pane 542, of a respective first input field 542-2b and a respective second input field 542-3b associated with the corresponding second draft email message.

In some embodiments, the device provides (616) display of a representation of a content-creation window of the application. As noted above, for example, in FIG. 5A, navigation window 510 includes content-creation window instantiation affordance 511 (e.g., a “compose new email message” button or the like).

The device detects (618) selection of the interface object while displaying the navigation window and the interface object. For example, as described above with reference to FIGS. 5A and 5G, focus selector 502 is used to select content-creation window instantiation affordance 511. In some embodiments, the device detects selection (620) by receiving a window movement input associated with selecting the portion of the content-creation window chrome, and determining that the window movement input includes movement towards the first edge of the navigation window. For example, transition to the structured arrangement in FIG. 5J (from FIG. 5M) is initiated when chrome area 541 is dragged to the right along direction indicator line 605 using focus selector 502. In some embodiments, the device determines (622) the window movement input also exceeds a displacement threshold towards the first edge of the navigation window, and in response, moves the content-creation window, movement of the content-creation window decoupled from ongoing and further window movement input until the content-creation window is in position as at least partially overlapping the provided display space. In some embodiments, the movement towards the first edge of the navigation window is less than all the way to the first edge of the navigation window. In some embodiments, the content-creation window is moved automatically without further user input. For example, with reference to FIG. 5M, in some embodiments, partial-screen tiled content-creation window 540 is moved to the final position, adjacent to partial-screen tiled navigation window 510 (shown in FIG. 5J), once partial-screen tiled content-creation window 540 has been dragged a threshold distance along direction indicator line 605.

The device adjusts (624) display of the navigation window in order to provide display space adjacent to a first edge of the navigation window. Further, in some embodiments, the device adjusts (626) display of the navigation window by tiling the navigation window from full-screen mode in order to provide the display space for the content-creation window. For example, as shown in the portion of the sequence shown in FIGS. 5G and 5H, full-screen tiled navigation window 510 is adjusted so that the display width is reduced producing partial-screen tiled navigation window 510, and a display space 530 is exposed, which was occupied by full-screen tiled navigation window 510 immediately before activation of content-creation window instantiation affordance 511.

In some embodiments, the device receives (628) a window movement input associated with selecting a portion of the content-creation window chrome, determines that the window movement input includes movement towards the bottom of the display, and in response, replaces display of the content-creation window with display of a corresponding content-creation window display affordance docked within a portion of the navigation window. In some embodiments, the device displays (630) the corresponding content-creation window display affordance with a plurality of content-creation window display affordances within the portion of the navigation window. In some embodiments, multiple new messages can also be minimized into a message bar (e.g., user interface region 547) that is displayed at the bottom of a full-screen user interface, where messages are indicated by adjacent tabs. For example, transition to the structured arrangement in FIG. 5N from FIG. 5M is initiated when chrome area 541 is dragged to down along direction indicator line 607 using focus selector 502. Responsively, as shown in FIG. 5N, display of partial-screen tiled content-creation window 540 ends, and full-screen tiled navigation window 510 is changed to include a user interface region 547 where message tabs 546-1, 546-2, 546-3, which were previously displayed in partial-screen tiled content-creation window 540, are displayed.

The device displays (632) a content-creation window as at least partially overlapping the provided display space that was occupied by the navigation window immediately before the display of the navigation window was adjusted in order to provide the display space. In some embodiments, the device displays (634), in response to detecting selection of the interface object, the content-creation window is displayed between an edge of the display and the first edge of the navigation window. For example, as described above with reference to FIGS. 5D and 5E, a content-creation window 540 (e.g., new email composition window) is displayed as at least partially overlapping display space 530 (shown in FIG. 5D) and adjacent to first edge 515 of navigation window 510. In some embodiments, the device displays (636) the content-creation window as an overlay over the navigation window, and the interface object includes a portion of the content-creation window chrome. For example, FIG. 5M includes partial-screen tiled content-creation window 540 displayed as an overlay over full-screen tiled navigation window 510.

In some embodiments, the device displays (638) interface object as one or more content-creation window display affordances (e.g., message display tabs) displayed in a first portion of the navigation window, and where content associated with the one or more content-creation window display affordances is not displayed (e.g., the message display tabs are displayed without displaying corresponding message content). For example, as shown in FIG. 5N, display of partial-screen tiled content-creation window 540 ends, and full-screen tiled navigation window 510 is changed to include a user interface region 547 where message tabs 546-1, 546-2, 546-3, which were previously displayed in partial-screen tiled content-creation window 540, are displayed without the associated content. In some embodiments, the device detects (640) selection of one of the plurality of content-creation window display affordances, and in response, displays corresponding content associated with the selected one of the plurality of content-creation display affordances in the content-creation window, while hiding from view the content associated with the others. For example, with reference to FIG. 5N, in some embodiments, selection of one of the message tabs 546-1, 546-2, 546-3 from within user interface region 547 causes the reintroduction of partial-screen tiled content-creation window 540 as an overlay on full-screen tiled navigation window 510 (as shown in FIG. 5M). In another example, with reference to FIG. 5N, selection of one of the message tabs 546-1, 546-2, 546-3 from within user interface region 547 causes the creation of a structured arrangement of partial-screen tiled content-creation window 540 in combination with partial-screen tiled navigation window 510 (as shown in FIG. 5J).

In some embodiments, the device displays (644) a plurality of content-creation window display affordances (e.g., message tabs) displayed in a first portion of the content-creation window, and where respective content associated with a corresponding one of the plurality of content-creation window display affordances is displayed in a second portion of the content-creation window. For example, as shown in FIG. 5F, content-creation window 540 includes a user interface region 546 having three message tabs 546-1, 546-2, 546-3, and in first pane 542 includes a respective first input field 542-2b and a respective second input field 542-3b associated with the corresponding second draft email message. In some embodiments, the device detects (644) selection of one of the plurality of content-creation window display affordances that is different from the corresponding one of the plurality content-creation window display affordances having respective content that is currently displayed, and in response, displays corresponding content associated with the selected one of the plurality of content-creation display affordances in the second portion of the content-creation window. For example, as shown in FIG. 5F, focus selector 502 is used select message tab 546-2 (“MSG2”), which causes display, in first pane 542, of a respective first input field 542-2b and a respective second input field 542-3b associated with the corresponding second draft email message. In some embodiments, the device displays (646) the content-creation window between an edge of the display and the first edge of the navigation window. In some embodiments, in accordance with detecting a movement of the content-creation window towards the center of the display, the device converts (648) the display of the content-creation window to an overlay covering at least a portion of the navigation window, and disables interaction with the navigation window. For example, with reference to FIG. 5I, dragging chrome area 541 towards the center of display 450 causes partial-screen tiled content-creation window 540 to be displayed as an overlay on full-screen tiled navigation window 510 (as shown in FIG. 5M). In some embodiments, when partial-screen tiled content-creation window 540 displayed as an overlay, as in FIG. 5M, user interaction associated with the full-screen tiled navigation window 510 is substantially disabled.

It should be understood that the particular order in which the operations in FIGS. 6A-6E have been described is merely exemplary and is not intended to indicate that the described order is the only order in which the operations could be performed. One of ordinary skill in the art would recognize various ways to reorder the operations described herein.

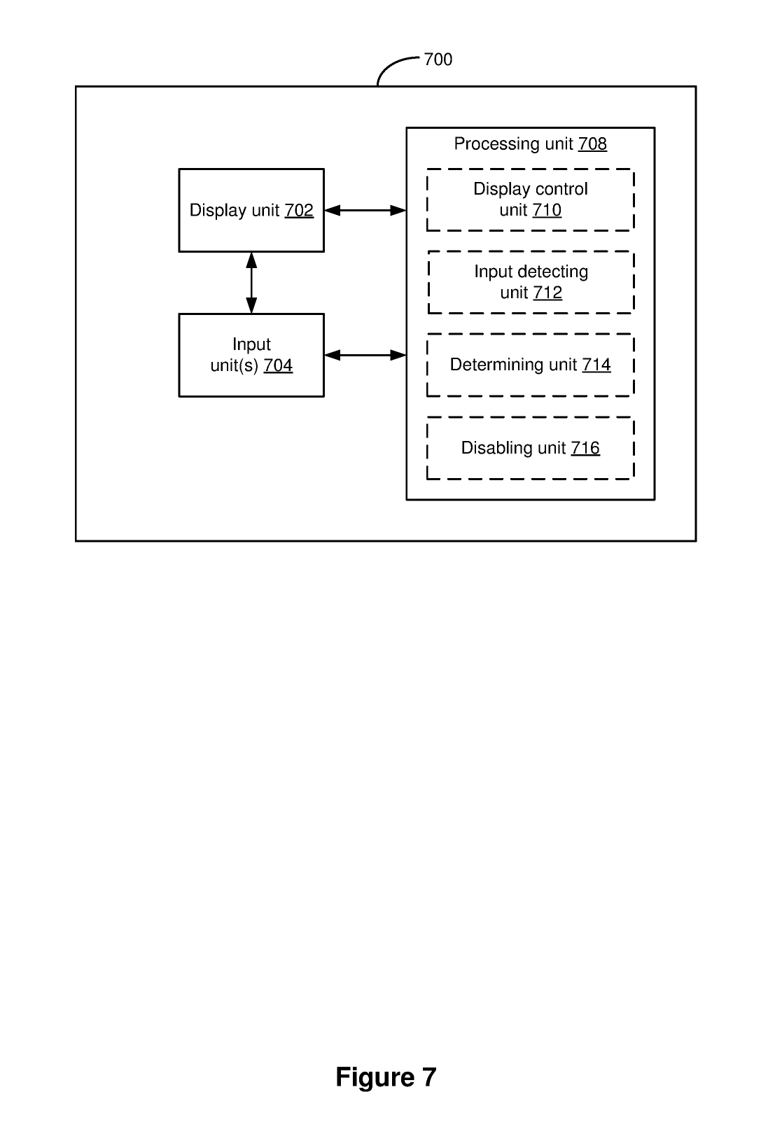

In accordance with some embodiments, FIG. 7 shows a functional block diagram of an electronic device 700 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 7 are, optionally, combined or separated into sub-blocks to implement the principles of the various described embodiments. Therefore, the description herein optionally supports any possible combination or separation or further definition of the functional blocks described herein.

As shown in FIG. 7, an electronic device 700 includes a display unit 702 configured to display a graphical user interface, a one or more input units 704 configured to receive user inputs, and a processing unit 708 coupled to the display unit 702 and the one or more input units 704. In some embodiments, the processing unit 708 includes: a display control unit 710, an input detecting unit 712, a determining unit 714, and a disabling unit 716.

In some embodiments, the processing unit 708 is configured to enable display of (e.g., with the display control unit 710) a navigation window of an application and an interface object associated with the navigation window. While displaying the navigation window and the interface object, the processing unit 708 is configured to detect (e.g., with the input detecting unit 712) selection of the interface object. In response to detecting selection of the interface object, the processing unit is configured to: adjust display of (e.g., with the display control unit 710) the navigation window in order to provide display space adjacent to a first edge of the navigation window; and enable display of (e.g., with the display control unit 710) a content-creation window as at least partially overlapping the provided display space that was occupied by the navigation window immediately before the display of the navigation window was adjusted in order to provide the display space.

In some embodiments, prior to adjusting display of the navigation window, displaying the navigation window of the application includes displaying the navigation window in full-screen mode.

In some embodiments, in response to detecting selection of the interface object, the content-creation window is displayed between an edge of the display unit 702 and the first edge of the navigation window.

In some embodiments, adjusting display of the navigation window includes tiling the navigation window from full-screen mode in order to provide the display space for the content-creation window.

In some embodiments, the processing unit 702 is configured to: receive (e.g., with the input detecting unit 712) a window movement input associated with selecting a portion of the content-creation window chrome; determine (e.g., with the determining unit 714) that the window movement input includes movement towards the bottom of the display unit 702; and, in response to determining that the window movement input includes movement towards the bottom of the display unit 702, replace display of (e.g., with the display control unit 710) the content-creation window with display of a corresponding content-creation window display affordance docked within a portion of the navigation window.

In some embodiments, the corresponding content-creation window display affordance is displayed with a plurality of content-creation window display affordances within the portion of the navigation window.

In some embodiments, prior to adjusting display of the navigation window, the processing unit 702 is configured to enable display of (e.g., with the display control unit 710) the content-creation window as an overlay over the navigation window, and where the interface object includes a portion of the content-creation window chrome.

In some embodiments, detecting selection of the interface object comprises: receiving a window movement input associated with selecting the portion of the content-creation window chrome; and determining that the window movement input includes movement towards the first edge of the navigation window.

In some embodiments, the processing unit 702 is configured to determine (e.g., with the determining unit 714) that the window movement input also exceeds a displacement threshold towards the first edge of the navigation window. In some embodiments, in response to determining that the window movement input also exceeds the displacement threshold towards the first edge of the navigation window, the processing unit 702 is configured to move (e.g., with the display control unit 710) the content-creation window, movement of the content-creation window decoupled from ongoing and further window movement input until the content-creation window is in position as at least partially overlapping the provided display space.

In some embodiments, the interface object includes a content-creation window instantiation affordance.

In some embodiments, the processing unit 702 is configured to: while displaying the content-creation window as at least partially overlapping the provided display space, detect (e.g., with the input detecting unit 712) a subsequent selection of the content-creation window instantiation affordance; and, in response to detecting the subsequent selection of the content-creation window instantiation affordance, enable display of (e.g., with the display control unit 710) a corresponding content-creation window display affordance within a first portion of the content-creation window, where respective content associated with at least one content-creation window display affordance is displayed in a second portion of the content-creation window.

In some embodiments, the corresponding content-creation window display affordance is displayed with a plurality of content-creation window display affordances within the first portion of the content-creation window.

In some embodiments, respective content associated with one or more displayed content-creation window display affordances is hidden from view.

In some embodiments, the processing unit 702 is configured to: while displaying the plurality of content-creation window display affordances, detect (e.g., with the input detecting unit 712) selection of one of the plurality of content-creation window display affordances; and, in response to detecting selection of one of the plurality of content-creation window display affordances, enable display of (e.g., with the display control unit 710) corresponding content associated with the selected one of the plurality of content-creation display affordances in the second portion of the content-creation window.

In some embodiments, the interface object includes one or more content-creation window display affordances displayed in a first portion of the navigation window, and where content associated with the one or more content-creation window display affordances is not displayed.

In some embodiments, the processing unit 702 is configured to: while displaying the plurality of content-creation window display affordances, detect (e.g., with the input detecting unit 712) selection of one of the plurality of content-creation window display affordances; and, in response to detecting selection of one of the plurality of content-creation window display affordances, enable display of (e.g., with the display control unit 710) corresponding content associated with the selected one of the plurality of content-creation display affordances in the content-creation window.

In some embodiments, the content-creation window includes display of a plurality of content-creation window display affordances displayed in a first portion of the content-creation window, and where respective content associated with a corresponding one of the plurality of content-creation window display affordances is displayed in a second portion of the content-creation window.

In some embodiments, the processing unit 702 is configured to: while displaying the plurality of content-creation window display affordances, detect (e.g., with the input detecting unit 712) selection of one of the plurality of content-creation window display affordances that is different from the corresponding one of the plurality content-creation window display affordances having respective content that is currently displayed; and, in response to detecting selection of one of the plurality of content-creation window display affordances that is different from the corresponding one of the plurality content-creation window display affordances having respective content that is currently displayed, enable display of (e.g., with the display control unit 710) corresponding content associated with the selected one of the plurality of content-creation display affordances in the second portion of the content-creation window.

In some embodiments, the interface object is provided to be selected in order to display a representation of a content-creation window of the application.

In some embodiments, the content-creation window is displayed between an edge of the display unit 702 and the first edge of the navigation window.

In some embodiments, in accordance with detecting a movement of the content-creation window towards the center of the display unit 702, the processing unit 702 is configured to: convert the display of (e.g., with the display control unit 710) the content-creation window to an overlay covering at least a portion of the navigation window; and disable (e.g., with the disabling unit 716) interaction with the navigation window.

The operations in the information processing methods described above are, optionally implemented by running one or more functional modules in information processing apparatus such as general purpose processors (e.g., as described above with respect to FIGS. 1A and 3) or application specific chips.

The operations described above with reference to FIGS. 6A-6E are, optionally, implemented by components depicted in FIGS. 1A-1B or FIG. 7. For example, displaying operation 602, detecting operation 618, and adjusting operation 624 are, optionally, implemented by event sorter 170, event recognizer 180, and event handler 190. For example, event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method, comprising:
at a device with a display, one or more input devices, one or more processors and a non-transitory memory:
displaying a navigation window of an application and an interface object associated with the navigation window;
while displaying the navigation window and the interface object, detecting selection of the interface object; and
in response to detecting selection of the interface object:
adjusting display of the navigation window in order to provide display space adjacent to a first edge of the navigation window; and
displaying a content-creation window as at least partially overlapping the provided display space that was occupied by the navigation window immediately before the display of the navigation window was adjusted in order to provide the display space.

2. The method of claim 1, wherein, prior to adjusting display of the navigation window, displaying the navigation window of the application includes displaying the navigation window in full-screen mode.

3. The method of claim 1, wherein, in response to detecting selection of the interface object, the content-creation window is displayed between an edge of the display and the first edge of the navigation window.

4. The method of claim 1, wherein adjusting display of the navigation window includes tiling the navigation window from full-screen mode in order to provide the display space for the content-creation window.

5. The method of claim 1, further comprising:
receiving a window movement input associated with selecting a portion of the content-creation window chrome;
determining that the window movement input includes movement towards the bottom of the display; and
in response to determining that the window movement input includes movement towards the bottom of the display:
replacing display of the content-creation window with display of a corresponding content-creation window display affordance docked within a portion of the navigation window.

6. The method of claim 5, wherein the corresponding content-creation window display affordance is displayed with a plurality of content-creation window display affordances within the portion of the navigation window.

7. The method of claim 1, wherein, prior to adjusting display of the navigation window:
displaying the content-creation window as an overlay over the navigation window, and wherein the interface object includes a portion of the content-creation window chrome.

8. The method of claim 7, wherein detecting selection of the interface object comprises:
receiving a window movement input associated with selecting the portion of the content-creation window chrome; and
determining that the window movement input includes movement towards the first edge of the navigation window.

9. The method of claim 8, further comprising:
determining that the window movement input also exceeds a displacement threshold towards the first edge of the navigation window;
wherein, in response to determining that the window movement input also exceeds the displacement threshold towards the first edge of the navigation window:
moving the content-creation window, movement of the content-creation window decoupled from ongoing and further window movement input until the content-creation window is in position as at least partially overlapping the provided display space.

10. The method of claim 1, wherein the interface object includes a content-creation window instantiation affordance.

11. The method of claim 10, further comprising:
while displaying the content-creation window as at least partially overlapping the provided display space, detecting a subsequent selection of the content-creation window instantiation affordance; and
in response to detecting the subsequent selection of the content-creation window instantiation affordance:
displaying a corresponding content-creation window display affordance within a first portion of the content-creation window, wherein respective content associated with at least one content-creation window display affordance is displayed in a second portion of the content-creation window.

12. The method of claim 10, wherein the corresponding content-creation window display affordance is displayed with a plurality of content-creation window display affordances within the first portion of the content-creation window.

13. The method of claim 10, wherein respective content associated with one or more displayed content-creation window display affordances is hidden from view.

14. The method of claim 12, further comprising:
while displaying the plurality of content-creation window display affordances, detecting selection of one of the plurality of content-creation window display affordances; and
in response to detecting selection of one of the plurality of content-creation window display affordances:
displaying corresponding content associated with the selected one of the plurality of content-creation display affordances in the second portion of the content-creation window.

15. The method of claim 1, wherein the interface object includes one or more content-creation window display affordances displayed in a first portion of the navigation window, and wherein content associated with the one or more content-creation window display affordances is not displayed.

16. The method of claim 15, further comprising:
while displaying the plurality of content-creation window display affordances, detecting selection of one of the plurality of content-creation window display affordances; and
in response to detecting selection of one of the plurality of content-creation window display affordances:
displaying corresponding content associated with the selected one of the plurality of content-creation display affordances in the content-creation window.

17. The method of claim 1, wherein the content-creation window includes display of a plurality of content-creation window display affordances displayed in a first portion of the content-creation window, and wherein respective content associated with a corresponding one of the plurality of content-creation window display affordances is displayed in a second portion of the content-creation window.

18. The method of claim 17, further comprising:
while displaying the plurality of content-creation window display affordances, detecting selection of one of the plurality of content-creation window display affordances that is different from the corresponding one of the plurality content-creation window display affordances having respective content that is currently displayed; and
in response to detecting selection of one of the plurality of content-creation window display affordances that is different from the corresponding one of the plurality content-creation window display affordances having respective content that is currently displayed:
displaying corresponding content associated with the selected one of the plurality of content-creation display affordances in the second portion of the content-creation window.

19. The method of claim 1, wherein the interface object is provided to be selected in order to display a representation of a content-creation window of the application.

20. The method of claim 1, wherein the content-creation window is displayed between an edge of the display and the first edge of the navigation window.

21. The method of claim 1, further comprising:
in accordance with detecting a movement of the content-creation window towards the center of the display:
converting the display of the content-creation window to an overlay covering at least a portion of the navigation window; and
disabling interaction with the navigation window.

22. An electronic device, comprising:
a display;
one or more input devices;
one or more processors;
a non-transitory memory; and
one or more programs, where the one or more programs are stored in the memory and configured to be executed by the one or more processors, the one or more programs including instructions for:
displaying a navigation window of an application and an interface object associated with the navigation window;
while displaying the navigation window and the interface object, detecting selection of the interface object; and
in response to detecting selection of the interface object:
adjusting display of the navigation window in order to provide display space adjacent to a first edge of the navigation window; and
displaying a content-creation window as at least partially overlapping the provided display space that was occupied by the navigation window immediately before the display of the navigation window was adjusted in order to provide the display space.

23. A non-transitory computer readable storage medium storing one or more programs, the one or more programs comprising instructions, which when executed by an electronic device with a display and one or more input devices, cause the electronic device to:
display a navigation window of an application and an interface object associated with the navigation window;
while displaying the navigation window and the interface object, detect selection of the interface object; and
in response to detecting selection of the interface object:
adjust display of the navigation window in order to provide display space adjacent to a first edge of the navigation window; and
display a content-creation window as at least partially overlapping the provided display space that was occupied by the navigation window immediately before the display of the navigation window was adjusted in order to provide the display space.

24. An electronic device, comprising:
a display;
one or more input devices;
means for displaying a navigation window of an application and an interface object associated with the navigation window;
means for detecting selection of the interface object while displaying the navigation window and the interface object; and
means, responsive to detecting selection of the interface object, for adjusting display of the navigation window in order to provide display space adjacent to a first edge of the navigation window; and
means, responsive to detecting selection of the interface object, for displaying a content-creation window as at least partially overlapping the provided display space that was occupied by the navigation window immediately before the display of the navigation window was adjusted in order to provide the display space.

25. An electronic device, comprising:
a display unit configured to display a graphical user interface;
one or more input units configured to receive user inputs; and
a processing unit coupled to the display unit and the one or more input units, the processing unit configured to:
enable display of a navigation window of an application and an interface object associated with the navigation window;
while displaying the navigation window and the interface object, detect selection of the interface object; and
in response to detecting selection of the interface object:
adjust display of the navigation window in order to provide display space adjacent to a first edge of the navigation window; and
enable display a content-creation window as at least partially overlapping the provided display space that was occupied by the navigation window immediately before the display of the navigation window was adjusted in order to provide the display space.

26. The electronic device of claim 25, wherein, prior to adjusting display of the navigation window, displaying the navigation window of the application includes displaying the navigation window in full-screen mode.

27. The electronic device of claim 25, wherein, in response to detecting selection of the interface object, the content-creation window is displayed between an edge of the display and the first edge of the navigation window.

28. The electronic device of claim 25, wherein adjusting display of the navigation window includes tiling the navigation window from full-screen mode in order to provide the display space for the content-creation window.

29. The electronic device of claim 25, wherein the processing unit is configured to:
receive a window movement input associated with selecting a portion of the content-creation window chrome;
determine that the window movement input includes movement towards the bottom of the display; and
in response to determining that the window movement input includes movement towards the bottom of the display:
replace display of the content-creation window with display of a corresponding content-creation window display affordance docked within a portion of the navigation window.

30. The electronic device of claim 29, wherein the corresponding content-creation window display affordance is displayed with a plurality of content-creation window display affordances within the portion of the navigation window.

31. The electronic device of claim 25, wherein, prior to adjusting display of the navigation window:
the processing unit is configured to enable display of the content-creation window as an overlay over the navigation window, and wherein the interface object includes a portion of the content-creation window chrome.

32. The electronic device of claim 31, wherein detecting selection of the interface object comprises:
receiving a window movement input associated with selecting the portion of the content-creation window chrome; and
determining that the window movement input includes movement towards the first edge of the navigation window.

33. The electronic device of claim 32, wherein:
the processing unit is configured to determine that the window movement input also exceeds a displacement threshold towards the first edge of the navigation window; and
in response to determining that the window movement input also exceeds the displacement threshold towards the first edge of the navigation window:
the processing unit is configured to move the content-creation window, movement of the content-creation window decoupled from ongoing and further window movement input until the content-creation window is in position as at least partially overlapping the provided display space.

34. The electronic device of claim 25, wherein the interface object includes a content-creation window instantiation affordance.

35. The electronic device of claim 34, wherein the processing unit is configured to:
while displaying the content-creation window as at least partially overlapping the provided display space, detect a subsequent selection of the content-creation window instantiation affordance; and
in response to detecting the subsequent selection of the content-creation window instantiation affordance:
enable display of a corresponding content-creation window display affordance within a first portion of the content-creation window, wherein respective content associated with at least one content-creation window display affordance is displayed in a second portion of the content-creation window.

36. The electronic device of claim 35, wherein the corresponding content-creation window display affordance is displayed with a plurality of content-creation window display affordances within the first portion of the content-creation window.

37. The electronic device of claim 35, wherein respective content associated with one or more displayed content-creation window display affordances is hidden from view.

38. The electronic device of claim 37, wherein the processing unit is configured to:
while displaying the plurality of content-creation window display affordances, detect selection of one of the plurality of content-creation window display affordances; and
in response to detecting selection of one of the plurality of content-creation window display affordances:
enable display of corresponding content associated with the selected one of the plurality of content-creation display affordances in the second portion of the content-creation window.

39. The electronic device of claim 25, wherein the interface object includes one or more content-creation window display affordances displayed in a first portion of the navigation window, and wherein content associated with the one or more content-creation window display affordances is not displayed.

40. The electronic device of claim 39, wherein the processing unit is configured to:
while displaying the plurality of content-creation window display affordances, detect selection of one of the plurality of content-creation window display affordances; and
in response to detecting selection of one of the plurality of content-creation window display affordances:
enable display of corresponding content associated with the selected one of the plurality of content-creation display affordances in the content-creation window.

41. The electronic device of claim 25, wherein the content-creation window includes display of a plurality of content-creation window display affordances displayed in a first portion of the content-creation window, and wherein respective content associated with a corresponding one of the plurality of content-creation window display affordances is displayed in a second portion of the content-creation window.

42. The electronic device of claim 41, wherein the processing unit is configured to:
while displaying the plurality of content-creation window display affordances, detect selection of one of the plurality of content-creation window display affordances that is different from the corresponding one of the plurality content-creation window display affordances having respective content that is currently displayed; and
in response to detecting selection of one of the plurality of content-creation window display affordances that is different from the corresponding one of the plurality content-creation window display affordances having respective content that is currently displayed:
enable display of corresponding content associated with the selected one of the plurality of content-creation display affordances in the second portion of the content-creation window.

43. The electronic device of claim 25, wherein the interface object is provided to be selected in order to display a representation of a content-creation window of the application.

44. The electronic device of claim 25, wherein the content-creation window is displayed between an edge of the display and the first edge of the navigation window.

45. The electronic device of claim 25, wherein the processing unit is configured to:
in accordance with detecting a movement of the content-creation window towards the center of the display:
convert the display of the content-creation window to an overlay covering at least a portion of the navigation window; and
disabling interaction with the navigation window.
